(19) United States
(12) Patent Application Publication
(10) Pub. No.: US 2011/0076572 A1
(43) Pub. Date: Mar. 31, 2011

(54) NON-AQUEOUS ELECTROLYTES FOR ELECTROCHEMICAL CELLS

(76) Inventors: Khalil Amine, Oakbrook, IL (US); Zonghai Chen, Bolingbrook, IL (US); Zhengcheng Zhang, Naperville, IL (US)

(21) Appl. No.: 12/888,715

(22) Filed: Sep. 23, 2010

Related U.S. Application Data
(60) Provisional application No. 61/245,747, filed on Sep. 25, 2009.

(51) Int. Cl. H01M 10/056

(52) U.S. Cl. 429/328; 429/326; 429/330

(57) ABSTRACT

A non-aqueous electrolyte includes an ionic electrolyte salt, and a non-aqueous electrolyte solvent that includes a mixture of siloxane or a silane or a mixture thereof, a sulfone, and a fluorinated ether or fluorinated ester or a mixture thereof, an ionic liquid, or a carbonate.

### CROSS-REFERENCE TO RELATED APPLICATIONS

This application claims the benefit of U.S. Provisional Patent Application No. 61/245,747, filed on Sep. 25, 2009, the entire disclosure of which is incorporated herein by reference for any and all purposes.

### GOVERNMENT RIGHTS

The United States Government has rights in this invention pursuant to Contract No. DE-AC02-06CH11357 between the United States Government and UChicago Argonne, LLC, representing Argonne National Laboratory.

### FIELD OF INVENTION

The present invention is generally directed to electrochemical cells. More particularly, the invention relates to non-aqueous electrolytes for use in electrochemical current producing cells, such as lithium ion battery, lithium-air batteries, and supercapacitors.

### BACKGROUND

The use of Li-ion batteries as rechargeable power sources represents a promising technology for use in the development of consumer electronics and electric-based vehicles. Conventional lithium ion batteries typically use non-aqueous electrolytes with a lithium salt such as LiPF₆ dissolved in carboxylic ester solvents such as ethylene carbonate, diethyl carbonate, dimethyl carbonate, ethyl methyl carbonate, γ-butyrolactone, etc. The electrolytes are then placed in an electrochemical cell using lithium transition metal oxides as the cathode and carbon or graphite as the anode. However, such conventional electrolyte solvents are flammable chemicals, and can be oxidatively cleaved into gaseous products between 4.2 and 5V vs. Li⁺/Li.

Lithium ion batteries with improved safety and high energy density are in increasing demand, especially for the HEV, PHEV and EV applications. Yet, the demand remains for a superior electrolyte with combined properties of high conductivity, high thermal stability, no toxicity, non-flammability, and high voltage stability. Energy released from a battery can be expressed by V×Q, where V and Q are the voltage and capacity of the battery, respectively. For capacitors, energy can be expressed by ½ CV², where C and V are capacitance and voltage of the capacitor, respectively. In both cases, because the energy is directly related to voltage, the higher the voltage, the more energy is released. Present development of high energy cells, such as lithium ion batteries and electric double layer capacitors, has been limited by the decomposition potential of electrolyte solvents on charged electrode surfaces. This is especially true for those cathodes operating at around 5.0 V.

Sulfone-based solvents are a potentially attractive group of organic solvents for electrolyte use which present anodic stability up to 5.5V on cathode surfaces. See Xu et. al, Journal of The Electrochemical Society, 145 (4) L70 (1998); 149 (7) A920 (2002); Sun et al., Electrochemistry Communications 7 (2005) 261, 11 (2009) 1418; Solid State Ionics 175 (2004) 257; Lu et al. Journal of The Electrochemical Society, 148 (7) A710 (2001); Seel et al. Journal of The Electrochemical Society, 147 (3) 892 (2000). However, sulfones exhibit high melting points (e.g 110° C. for dimethyl sulfone) and high viscosity due to their symmetrical molecular structure. Thus, when electrolyte salts are dissolved in these solvents for the purpose of improving the ionic conductivity of the solvents, the viscosity of the solvent and salt becomes too high for efficient use as an electrolyte. Additionally, due to the high melting points of sulfones, the working temperature of the cell containing symmetrical sulfones is also high, between 100˜150° C., with the consequence that the self-discharge and loss of capacity are high. Unsymmetrical, polar sulfones have relative low melting points, high dielectric constant and higher conductivity. However, the use of polar sulfone solvents is inhibited by their incompatibility with hydrophobic separators and with the non-polar binders for cathode. See Angell et al. U.S. Pat. No. 6,245,465 B1; US 2007/0298326 A1; Yen et al. U.S. Pat. No. 4,550,064.

It has recently been reported that fluorinated ether/esters are suitable as electrolyte solvents due to their anti-oxidation, wide liquid range, high dielectric constant, non-flammability, and excellent low temperature performance. See Koh et al. US 2008/0145763 A1; US2009/0086408 A1; Woo et al. U.S. Pat. No. 7,268,238 B2; McMillan et al. Journal of Power Sources 81-82 (1999) 20. However, they have poor conductivity as a single component electrolyte, and they are not compatible with convention carbonate electrolytes.

### SUMMARY

In one aspect, a non-aqueous electrolyte is provided including a ionic electrolyte salt and a non-aqueous electrolyte solvent. In some embodiments, the non-aqueous electrolyte solvent includes two or more of a siloxane or a silane, a sulfone; a fluorinated ether or fluorinated ester; and a room temperature ionic liquid. In some embodiments, the non-aqueous electrolyte may further include a carbonate compound.

In some embodiments, the non-aqueous electrolyte solvent includes one or more silanes or siloxanes. In some embodiments, the siloxane is a disiloxane. In some embodiments, the siloxane is a trisiloxane.

In some embodiments, the sulfone is a compound of Formula I

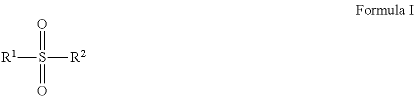

where R¹ and R² are individually a C₁-C₇ alkyl group that is unsubstituted, or is substituted with one or more fluorine atoms; or a C₁-C₇ group having one or more oxygen atoms; or R¹ and R² join together to form a cyclic alkyl that is unsubstituted or is substituted with one or more fluorine atoms. In some embodiments, the sulfones is sulfolane.

In some embodiments, the fluorinated ester is a fluorinated carbonate. In some embodiments, the fluorinated carbonate is a compound of Formula II

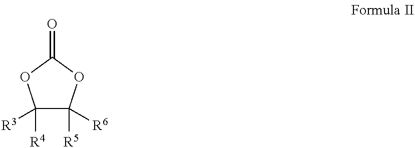

where, R³ is a fluorine-containing alkyl group, a fluorine-containing alkoxyl group or a fluorine-containing ether group with two or more carbon atoms; R⁴ and R⁵ are individually H, F, Cl, CF₃ or CH₃; and R⁶ is H, F, Cl or an alkyl group. In some embodiments, R³ is a C₁-C₅ alkyl group having at least one F, and that is optionally further substituted with one or more Cl.

In some embodiments, the fluorinated carbonate is a compound of Formula III,

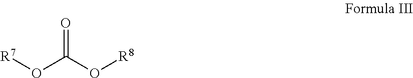

wherein R⁷ and R⁸ are individually a fluorine-containing C₁ to C₈ alkyl group, a fluorine-containing C₁ to C₈ alkoxyl group or a fluorine-containing C₁ or C₂ ether group. In some embodiments, the compound of Formula VI is selected from the group consisting of [H(CF₂)₂CH₂]₂CO₃; HF₂CCF₂CH₂OC(O)OCH₂CF₂CH₂F; HF₂CCF₂CH₂OC(O)OCH₂CH₂CF₂CF₂H; FH₂CCF₂CH₂OC(O)OCH₂CF₂CF₂H; [FCH₂CF₂CH₂]₂CO₃; FCH₂CF₂CH₂OC(O)OCH₂CH₂CF₂CF₂H; HF₂CCF₂CH₂CH₂OC(O)OCH₂CF₂CF₂H; HF₂CCF₂CH₂CH₂OC(O)OCH₂CF₂CH₂F; [HF₂CCF₂CH₂CH₂]₂CO₃; CF₃CF₂CH₂OC(O)OCH₂CF₂CF₂H; CF₃CF₂CH₂OC(O)OCH₂CF₂CH₂F; CF₃CF₂CH₂OC(O)OCH₂CH₂CF₂CF₂H; CF₃CH₂CH₂OC(O)OCH₂CF₂CF₂H; CF₃CH₂CH₂OC(O)OCH₂CF₂CH₂F; CF₃CH₂CH₂OC(O)OCH₂CH₂CF₂CF₂H; (CF₃)₂CFCH₂CH₂OC(O)OCH₂CF₂CF₂H; (CF₃)₂CFCH₂CH₂OC(O)OCH₂CF₂CH₂F; and (CF₃)₂CFCH₂CH₂OC(O)OCH₂CH₂CF₂CF₂H.

In some embodiments, the fluorinated ether is F₃CCHFCF₂OCH₃; F₃CCHFCF₂OCH₂F; F₃CCHFCF₂OCF₂H; F₃CCHFCF₂OCF₃; (CF₃)₂CHCF₂OCH₃; (CF₃)₂CHCF₂OCH₂F; (CF₃)₂CHCF₂OCHF₂; (CF₃)₂CHCF₂OCF₃; F₃CFC═CFOCH₃; F₃CFC═CFOCH₂F; F₃CFC═CFOCHF₂; F₃CFC═CFOCF₃; F₂C═CFCF₂OCH₃; F₂C═CFCF₂OCH₂F; F₂C═CFCF₂OCF₂H; F₂C═CFCF₂OCF₃; (CF₃)₂C═CFOCH₃; (CF₃)₂C═CFOCH₂F; (CF₃)₂C═CFOCF₂H; (CF₃)₂C═CFOCF₃; F₂C═C(CF₃)CF₂OCH₃; F₂C═C(CF₃)CF₂OCH₂F; F₂C═C(CF₃)CF₂OCF₂H; or F₂C═C(CF₃)CF₂OCF₃.

In some embodiments, the carbonate compound includes aprotic solvents or carriers. For example, suitable carbonate compounds include, but are not limited to propylene carbonate, ethylene carbonate, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, and γ-butyrolactone.

In some embodiments, the non-aqueous electrolyte also includes an electrode stabilizing additive. Suitable electrode stabilizing additives include, but are not limited to, 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2 amino-3 vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2 vinyloxetane, 2-vinyloxycyclopropanone, 3-(N-vinylamino)cyclohexanone, 3,5-divinyl furoate, 3-vinylazetidin-2-one, 3 vinylaziridin 2 one, 3 vinylcyclobutanone, 3 vinylcyclopentanone, 3 vinyloxaziridine, 3 vinyloxetane, 3-vinylpyrrolidin-2-one, 4,4 divinyl-3 dioxolan 2-one, 4 vinyltetrahydropyran, 5-vinylpiperidin-3-one, allylglycidyl ether, butadiene monoxide, butyl vinyl ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone, (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)-cyclotriphosphazene, (diaryloxy)(trifluoro)(methoxy)cyclotriphosphazene, tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl) pentafluorophenylboronate, or a mixture of any two or more such compounds. In some embodiments, the electrode stabilizing additive is vinyl ethylene carbonate, vinyl carbonate, 1,2-diphenyl ether, or a mixture of any two or more such compounds. In other embodiments, a concentration of the electrode stabilizing additive is from about 0.1 wt % to about 35 wt %, from about 0.1 wt % to about 30 wt %, from about 0.1 wt % to about 25 wt %, from about 0.1 wt % to about 20 wt %, from about 0.1 wt % to about 10 wt %, from about 0.1 wt % to about 5 wt %, from about 0.1 wt % to about 3 wt %, from about 0.1 wt % to about 2 wt %, from about 0.1 wt % to about 1 wt %, from about 0.5 wt % to about 10 wt %, from about 0.5 wt % to about 3 wt %, or from about 0.5 wt % to about 2 wt %.

In another aspect, an electrochemical cell is provided which includes an anode, a cathode, and a non-aqueous electrolyte. In some embodiments, the electrochemical cell also includes a separator. In some embodiments, the separator is a microporous polymer film that is nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. In some embodiments, the electrochemical cell is a secondary battery. In some embodiments, the secondary battery is a lithium battery, a lithium-ion battery, a lithium-sulfur battery, a lithium-air battery, a sodium ion battery, or a magnesium battery. In some embodiments, the electrochemical cell is a capacitor. In some embodiments, the capacitor is an asymmetric capacitor or supercapacitor. In some embodiments, the electrochemical cell is a primary cell. In some embodiments, the primary cell, that is a lithium/MnO₂ battery or Li/carbon monofluoride battery. In some embodiments, the electrochemical cell is a solar cell.

### BRIEF DESCRIPTION OF THE DRAWINGS

FIG. 1 is a graph illustrating the temperature dependence of ionic conductivity of 1.0M LiPF₆ in a blend of TMS:1NM3 in weight ratios of 9:1, 4:1, 7:3 and 1:1, according to one embodiment.

FIG. 2 is a cyclic voltammogram of 1.0M LiPF₆ in TMS:1NM3 at a weight ratio of 1:1, according to one embodiment.

FIG. 3 is a series of charge/discharge profiles of coin cells using 1.0M LiPF₆ in TMS:1NM3 at a weight ratio of 1:1 using a cathode of Li_{1.2}Ni_{0.15}Co_{0.10}Mn_{0.55}O₂, an anode of Li₄Ti₅O₁₂, a separator that is Celgard 2325, according to one embodiment.

FIG. 4 is a graph illustrating the cycling performance of coin cells using 1.0M LiPF₆ in TMS:1NM3 at a weight ratio of 1:1 using a cathode of Li_{1.2}Ni_{0.15}Co_{0.10}Mn_{0.55}O₂, an anode of Li₄Ti₅O₁₂, a separator that is Celgard 2325, according to one embodiment.

FIG. 5 is a graph illustrating the cycling performance of a lithium ion cell using an electrolyte of 1.0M LiPF₆ TMS:1NM3 at a weight ratio of 1:1 using LiMn₂O₄ as a positive electrode, Li₄Ti₅O₁₂ as a negative electrode, and Celgard 2325 as a separator, according to one embodiment.

FIG. 6 is a graph illustrating the cycling performance of a lithium ion cell using an electrolyte 1.0M LiPF₆ in TMS:1NM3 at a 1:1 weight ratio with 4 wt % LiDfOB, and using LiNi_{1/3}Mn_{1/3}Co_{1/3}O₂ as the positive electrode, MCMB as the negative electrode and Celgard 2325 as the separator, according to one embodiment.

FIG. 7 is a graph illustrating the cycling performance of a lithium ion cell using an electrolyte of 1.0M LiPF₆ in TMS:1NM3 at a 1:1 weight ratio with 2% VC, and using LiNi_{1/3}Mn_{1/3}Co_{1/3}O₂ as a positive electrode, MCMB as a negative electrode, and Celgard 2325 as a separator, according to one embodiment.

FIG. 8 is a graph of 1^{st} charge dQ/dV plots for cells using NMC as cathode and MCMB as anode. The electrolytes illustrated are 1.2M LiPF₆ in EC/EMC at a weight ratio of 3/7; 1.0M LiPF₆ in TMS:1NM3 at a weight ratio of 1:1 with 2% Li[BF₂C₂O₄] (“LiDfOB”), 2% vinylene carbonate (“VC”), and of 4% LiDfOB and 4% VC, according to some embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, the following definitions of terms shall apply unless otherwise indicated.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In general, “substituted” refers to a group, as defined below (e.g., an alkyl or aryl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, carbonyls(oxo), carboxyls, esters, urethanes, thiols, sulfides, sulfoxides, sulfones, sulfonyls, sulfonamides, amines, isocyanates, isothiocyanates, cyanates, thiocyanates, nitro groups, nitriles (i.e., CN), and the like.

Alkyl groups include straight chain and branched alkyl groups having from 1 to 20 carbon atoms or, in some embodiments, from 1 to 12, 1 to 8, 1 to 6, or 1 to 4 carbon atoms. Alkyl groups further include cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above. Where the term haloalkyl is used, the alkyl group is substituted with one or more halogen atoms.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems, such as, for example bridged cycloalkyl groups as described below, and fused rings, such as, but not limited to, decalinyl, and the like. In some embodiments, polycyclic cycloalkyl groups have three rings. Substituted cycloalkyl groups may be substituted one or more times with, non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Alkenyl groups include straight and branched chain and cycloalkyl groups as defined above, except that at least one double bond exists between two carbon atoms. Thus, alkenyl groups have from 2 to about 20 carbon atoms, and typically from 2 to 12 carbons or, in some embodiments, from 2 to 8, 2 to 6, or 2 to 4 carbon atoms. In some embodiments, alkenyl groups include cycloalkenyl groups having from 4 to 20 carbon atoms, 5 to 20 carbon atoms, 5 to 10 carbon atoms, or even 5, 6, 7, or 8 carbon atoms. Examples include, but are not limited to vinyl, allyl, CH═CH(CH₃), CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

Alkynyl groups include straight and branched chain alkyl groups, except that at least one triple bond exists between two carbon atoms. Thus, alkynyl groups have from 2 to about 20 carbon atoms, and typically from 2 to 12 carbons or, in some embodiments, from 2 to 8, 2 to 6, or 2 to 4 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃), among others. Representative substituted alkynyl groups may be mono-substituted or substituted more than once, such as, but not limited to, mono-, di- or tri-substituted with substituents such as those listed above.

Aryl, or arene, groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. Although the phrase “aryl groups” includes groups containing fused rings, such as fused aromatic-aliphatic ring systems (e.g., indanyl, tetrahydronaphthyl, and the like), it does not include aryl groups that have other groups, such as alkyl or halo groups, bonded to one of the ring members. Rather, groups such as tolyl are referred to as substituted aryl groups. Representative substituted aryl groups may be mono-substituted or substituted more than once. For example, monosubstituted aryl groups include, but are not limited to, 2-, 3-, 4-, 5-, or 6-substituted phenyl or naphthyl groups, which may be substituted with substituents such as those listed above.

“Alkoxy” refers to the group —O-alkyl wherein alkyl is defined herein. Alkoxy includes, by way of example, methoxy, ethoxy, n-propoxy, isopropoxy, n-butoxy, t-butoxy, sec-butoxy, and n-pentoxy.

“Amino” refers to the group —NH₂. “Cyano” refers to the group —CN. “Carbonyl” refers to the divalent group —C(O)— which is equivalent to —C(═O)—. “Nitro” refers to the group —NO₂. “Oxo” refers to the atom (═O). “Sulfonyl” refers to the divalent group —S(O)₂—. “Thiol” refers to the group —SH. “Thiocarbonyl” refers to the divalent group —C(S)— which is equivalent to —C(═S)—. “Hydroxy” or “hydroxyl” refers to the group —OH.

As used herein a room temperature ionic liquid (RTILs) is an ionic liquid that, when neat (i.e. not dissolved in a solvent), is in a liquid state and stable at room temperature. RTILs may be used as electrolyte materials for electrochemical devices. Generally, RTILs are well known to be thermally stable and non-flammable and their nature.

In one aspect, a non-aqueous electrolyte is provided, the electrolyte including a non-aqueous electrolyte solvent that includes two or more of a sulfone, a siloxane or silane, a fluorinated ether or fluorinated ester, or a room temperature ionic liquid. Such solvents can form a eutectic point, and may be used in electrochemical cells. The non-aqueous electrolyte also includes an ionic electrolyte salt. In some embodiments, the electrolyte also includes a carbonate solvent. Methods of making the electrolytes, electrochemical cells prepared using the electrolytes, and methods of preparing the electrochemical cells are also provided. The non-aqueous electrolytes exhibit good wetting stability, low vapor pressure, low viscosity, high ionic conductivity, oxidative durability, and reversible lithium ion intercalation into lithium ion anodes for secondary cells. The non-aqueous electrolytes also impart, a wide liquid range, are non-flammable, increased the cycle life, and safety to secondary cells.

In some embodiments, the non-aqueous electrolyte solvents include a sulfone that is a compound of Formula I

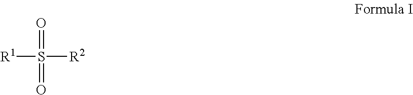

In Formula I, R¹ and R² are individually a C₁-C₇ alkyl group that is unsubstituted, or is substituted with one or more fluorine atoms, or a C₁-C₇ group having one or more oxygen atoms; or R¹ and R² join together to form a cyclic alkyl that is unsubstituted or is substituted with one or more fluorine atoms. In some embodiments, the sulfone is a symmetrical sulfone in which R¹ and R² are identical. For example, where R¹ and R² are both ethyl, the compound is diethylsulfone: [(CH₃CH₂)₂SO₂]. In other embodiments, the sulfone is an asymmetrical sulfone in which R¹ and R² are different. For example, where R¹ is methyl and R² is ethyl, the compound is ethylmethylsulfone: [(CH₃CH₂)(CH₃)SO₂]. In yet other embodiments, the sulfones are cyclic sulfones where R¹ and R² have joined together. For example, where R¹ and R² join together as a tetramethylene group, the compound is tetramethylene sulfone, otherwise known as sulfolane:

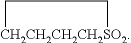

Such sulfones have a high anodic decomposition potential, and can withstand voltage differentials between the anode and cathode of greater than 5 volts vs. lithium.

In some embodiments, R¹ and R² are individually methyl; ethyl; n-propyl; iso-propyl; n-butyl; iso-butyl; sec-butyl; tert-butyl; n-pentyl; iso-pentyl; n-hexyl; n-heptyl; trifluoromethyl; 2,2,2-trifluoroethyl; 1,1-difluoroethyl; perfluoroethyl; 3,3,3-trifluoro-n-propyl; 2,2-difluoro-n-propyl; 1,1-difluoro-n-propyl; 2,2,3,3,3-pentafluoro-n-propyl; 1,1,3,3,3-pentafluoro-n-propyl; perfluoro-n-propyl; perfluoro-n-butyl; perfluoro-n-pentyl; perfluoro-n-hexyl; perfluoro-n-heptyl; —CH₂OCH₃; —CF₂OCH₃; —CF₂OCF₃; —CH₂CH₂OCH₃; —CH₂CF₂OCH₃; —CF₂CH₂OCH₃; —CF₂CF₂OCH₃; —CF₂CF₂OCF₃; —CF₂CH₂OCF₃; —CH₂CF₂OCF₃; —CH₂CH₂OCF₃; —CHFCF₂OCF₂H; —CF₂CF₂OCF(CF₃)₂; —CF₂CH₂OCF(CF₃)₂; —CH₂CF₂OCF(CF₃)₂; —CH₂CH₂OCF(CF₃)₂; —CF₂CF₂OC(CF₃)₃; —CF₂CH₂OC(CF₃)₃; —CH₂CF₂OC(CF₃)₃; —CH₂CH₂OC(CF₃)₃; —CH₂CH₂OCH₂CH₃; —CH₂CH₂OCH₂CF₃; —CH₂CH₂OCF₂CH₃; —CH₂CH₂OCF₂CF₃; —CH₂CF₂OCH₂CH₃; —CH₂CF₂OCF₂CH₃; —CH₂CF₂OCH₂CF₃; —CH₂CF₂OCF₂CF₃; —CF₂CH₂OCH₂CH₃; —CF₂CH₂OCF₂CH₃; —CF₂CH₂OCH₂CF₃; —CF₂CH₂OCF₂CF₃; —CF₂CF₂OCH₂CH₃; —CF₂CF₂OCF₂CH₃; —CF₂CF₂OCH₂CF₃; —CF₂CF₂OCF₂CF₃; —CF₂CF₂CF₂OCH₃; —CF₂CF₂CH₂OCH₃; —CF₂CH₂CF₂OCH₃; —CH₂CF₂CF₂OCH₃; —CH₂CF₂CH₂OCH₃; —CH₂CH₂CF₂OCH₃; —CF₂CH₂CH₂OCH₃; —CH₂CH₂CH₂OCH₃; —CF₂CF₂CF₂OCF₃; —CF₂CF₂CH₂OCF₃; —CF₂CH₂CF₂OCF₃; —CH₂CF₂CF₂OCF₃; —CH₂CH₂CF₂OCF₃; —CH₂CF₂CH₂OCF₃; —CF₂CH₂CH₂OCF₃; —CH₂CH₂CH₂CH₂OCH₃; —CH₂CH₂CH₂CH₂CH₂OCH₃; —CH₂CH₂CH₂CH₂CH₂CH₂OCH₃; —CH₂CH₂OCH₂CH₂OCH₃; or —CH₂CH₂OCH₂CH₂OCH₂CH₂OCH₃. Alternatively, R¹ and R² may join together to form a cyclic sulfones. For example, where R¹ and R² join together as a tetramethylene group, the sulfone is commonly known as sulfolane.

According to some embodiments, the siloxanes and/or silanes include oligo(ethylene glycol)-substituted silanes, oligo(ethylene glycol)-substituted disiloxanes, or oligo(ethylene glycol)-substituted trisiloxanes. In some embodiments, the Si atoms in the disiloxanes and trisiloxanes are partially substituted or fully substituted. Such siloxanes or silanes include a silicon or silicon oxide group having four or less substituents that is an oligo(alkylene glycol), or cyclic carbonate moiety. The siloxanes or silanes may be include up to four such substituents. In some embodiments, where the siloxane or silane has less than four such substituents, the siloxane or silane may include substituents other than an oligo(alkylene glycol) or cyclic carbonate moiety. As used herein, a silane has a silicon atom that is bonded to hydrogen and/or carbon atoms, while a siloxane has at least two silicon atoms bonded to one oxygen atom.

In one embodiment, the non-aqueous electrolyte solvent includes a silane compound of general Formula IV:

SiR⁹_{4-x-y}R¹⁰ₓR¹¹_{y} Formula IV

In Formula IV, each R⁹ is individually an alkyl, alkenyl group, alkynyl group, alk(poly)enyl group, alk(poly)ynyl group, or aryl group, each of which may further include substituents such as aryl groups, alkoxy groups, or monovalent ether groups. In Formula IV, R¹⁰ is selected from Group I or Group II, and R¹¹ is selected from Group I or Group III. In Formula IV, x is 1, 2, 3, or 4, and y is 0, 1, 2, or 3, where the sum of x and y is greater than or equal to one. Groups I, II, and III are:

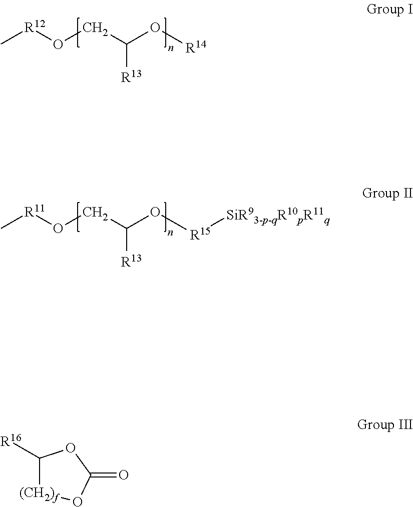

where R⁹, R¹⁰, and R¹¹ are as defined above; each R¹² is individually a bond or a divalent spacer; each R¹³ and R¹⁴ are individually hydrogen, alkyl, or aryl; each R¹⁵ is individually alkyl or aryl; each R¹⁶ is individually a divalent organic spacer; f is 1 or 2; n is an integer from 0 to 15; p is 0, 1, 2, or 3; and q is 0, 1, 2, or 3. In some embodiments, each of R⁹, R¹⁰, and R¹¹ are individually an alkyl group, alkenyl group, alkynyl group, alkoxy group, alk(poly)enyl group, alk(poly)ynyl group, or aryl group, each of which may further include substituents such as aryl groups, alkoxy groups, or monovalent ether groups. In some embodiments, n is an integer from 1 to 15. In other embodiments, R⁹, R¹⁰, and R¹¹ are individually an alkyl, aryl, or alkoxy group.

In some embodiments, a siloxane includes a silicon linked to one side chain that includes an oligo(alkylene glycol) moiety, bonded to the silicon through an oxygen atom, and the silicon is bonded to three other substituents. For instance, the silane can be represented by Formula IV where x is one, y is zero, R¹⁰ is a Group I, and R¹² is a bond. In other embodiments, a silane includes a silicon linked to one side chain that includes an oligo(alkylene glycol) moiety, bonded to the silicon through an organic spacer group, and the silicon is bonded to three other substituents. For instance, the silane can be represented by Formula IV, where x is one, y is zero, R¹⁰ is a Group I, and R¹² is other than a bond.

Exemplary compounds of Formula IV, include, but are not limited to, Formulas IV-A, IV-B, IV-C, IV-D, IV-E, and IV-F:

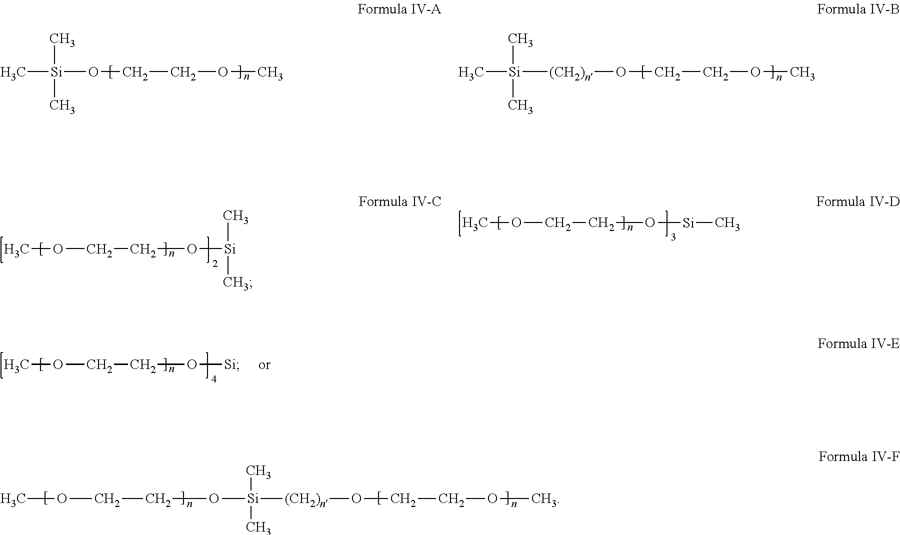

In Formulas IV-A, IV-B, IV-C, IV-D, IV-E, and IV-F each n is individually an integer from 1 to 15 (e.g. 1, 2, 3, 4, 5, 6, 7, 8, 9, 10, 11, 12, 13, 14, or 15). In some embodiments, each n is individually an integer from 2 to 15. In some embodiments, n is three. In some embodiments of Formulas IV-A, IV-B, IV-C, IV-D, IV-E, and IV-F, each n′ is an integer selected from one, two, or three. In other embodiments, each n′ is one or three.

Other exemplary silanes include, but are not limited to, (CH₃)₃SiO(CH₂CH₂O)ₙCH₃, (CH₃)₃SiCH₂O(CH₂CH₂O)ₙCH₃, (CH₃)₃Si(CH₂)₃O(CH₂CH₂O)_{n′}CH₃, (CH₃)₂Si[O(CH₂CH₂O)_{n′}CH₃]₂, CH₃Si[O(CH₂CH₂O)ₚCH₃]₃, Si[O(CH₂CH₂O)_{p′}CH₃]₄, (CH₃)₂Si[O(CH₂CH₂O)_{n′}CH₃][(CH₂)₃O(CH₂CH₂O)_{n′}CH₃], (CH₃)₃SiOR, and (CH₃)₃Si(CH₂)₃OR, where R is a carbonate group, n is 2, 3, 4, 5, 6, or 7; n′ is 2, 3, 4, or 5; p is 2, 3, or 4; and p′ is 2 or 3. Specific examples, include, but are not limited to (CH₃)₃SiO(CH₂CH₂O)₂CH₃, (CH₃)₃SiO(CH₂CH₂O)₃CH₃, (CH₃)₃SiO(CH₂CH₂O)₄CH₃, (CH₃)₃SiO(CH₂CH₂O)₅CH₃, (CH₃)₃SiO(CH₂CH₂O)₆CH₃, (CH₃)₃SiO(CH₂CH₂O)₇CH₃; (CH₃)₃SiCH₂O(CH₂CH₂O)₂CH₃, (CH₃)₃SiCH₂O(CH₂CH₂O)₃CH₃, (CH₃)₃SiCH₂O(CH₂CH₂O)₄CH₃, (CH₃)₃SiCH₂O(CH₂CH₂O)₅CH₃, (CH₃)₃SiCH₂O(CH₂CH₂O)₆CH₃, (CH₃)₃SiCH₂O(CH₂CH₂O)₇CH₃; (CH₃)₃Si(CH₂)₃O(CH₂CH₂O)₂CH₃, (CH₃)₃Si(CH₂)₃O(CH₂CH₂O)₃CH₃, (CH₃)₃Si(CH₂)₃O(CH₂CH₂O)₄CH₃, (CH₃)₃Si(CH₂)₃O(CH₂CH₂O)₅CH₃; (CH₃)₂Si[O(CH₂CH₂O)₂CH₃]₂, (CH₃)₂Si[O(CH₂CH₂O)₃CH₃]₂, (CH₃)₂Si[O(CH₂CH₂O)₄CH₃]₂, (CH₃)₂Si[O(CH₂CH₂O)₅CH₃]₂; CH₃Si[O(CH₂CH₂O)₂CH₃]₃, CH₃Si[O(CH₂CH₂O)₃CH₃]₃, CH₃Si[O(CH₂CH₂O)₄CH₃]₃; Si[O(CH₂CH₂O)₂CH₃]₄, Si[O(CH₂CH₂O)₃CH₃]₄; (CH₃)₂Si[O(CH₂CH₂O)₂CH₃][(CH₂)₃O(CH₂CH₂O)₂CH₃], (CH₃)₂Si[O(CH₂CH₂O)₃CH₃][(CH₂)₃O(CH₂CH₂O)₃CH₃], (CH₃)₂Si[O(CH₂CH₂O)₄CH₃][(CH₂)₃O(CH₂CH₂O)₄CH₃], and (CH₃)₂Si[O(CH₂CH₂O)₅CH₃][(CH₂)₃O(CH₂CH₂O)₅CH₃].

In one embodiment, the non-aqueous electrolyte solvent includes a disiloxane compound. Suitable disiloxanes include a backbone with a first silicon and a second silicon. The first silicon is linked to a first substituent that includes an oligo(alkylene glycol) moiety or a cyclic carbonate moiety. For instance, the first silicon can be selected from a group consisting of a first side-chain that includes an oligo(alkylene glycol) moiety, a first side-chain that includes a cyclic carbonate moiety or a cross-linker that includes a oligo(alkylene glycol) moiety which cross-links the disiloxane to a second siloxane. In some instances, the disiloxanes include no more than one oligo(alkylene glycol) moiety and/or no more than one cyclic carbonate moiety. For instance, the entities linked to the first silicon and the second silicon, other than the first substituent, can each exclude an oligo(alkylene glycol) moiety and/or a cyclic carbonate moiety. In some instances, the disiloxane excludes an oligo(alkylene glycol) moieties or excludes cyclic carbonate moieties. In some embodiments, the inorganic salt is a lithium salt.

The second silicon can be linked to a second substituent that is a second side-chain that includes an oligo(alkylene glycol) moiety and a second side-chain that includes a cyclic carbonate moiety. In some instances, the disiloxanes include no more than two oligo(alkylene glycol) moieties and/or no more than two cyclic carbonate moieties. For instance, the entities linked to the first silicon and the second silicon, in addition to the first substituent and the second substituent, can each include an oligo(alkylene glycol) moiety and/or a cyclic carbonate moiety.

In some embodiments, the disiloxanes are represented by Formula V:

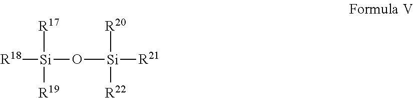

where R¹⁷, R¹⁹, R²⁰, and R²² are individually an alkyl group or an aryl group; R¹⁸ is an alkyl group, an aryl group, an oligo(alkylene glycol) group, or an alkylcyclic carbonate group; and R²¹ is an alkyl group, an aryl group, an oligo(alkylene glcycol) group, an alkylcyclic carbonate group, Group I, Group II, or Group III. In some embodiments, R¹⁸ is selected from Group I, Group II, or Group III. In other embodiments, R²¹ is an alkyl group, an aryl group, Group I, or Group III. In some embodiments, R²¹ is selected from Group I or Group III. In some embodiments, R¹⁸ is selected from an alkyl group, an aryl group, or Group I. In other embodiments, R¹⁸ is an alkyl, an aryl, or Group III. In some embodiments, R¹⁷, R¹⁹, R²⁰, and R²² are individually an alkyl group. For example, R¹⁷, R¹⁹, R²⁰, and R²² may individually be a methyl, ethyl, n-propyl, iso-propyl, n-butyl, iso-butyl, or tert-butyl group. In some embodiments, R¹⁷, R¹⁹, R²⁰, and R²² are each a methyl group.

In one example of the disiloxane, the first substituent is a side chain that includes an oligo(alkylene glycol) moiety. The oligo(alkylene glycol) moiety can include an oxygen linked directly to the first silicon. For instance, the disiloxanes can be represented by Formula V, where R²¹ is a Group I, and R¹² is a bond. Alternately, a spacer can link the oligo(alkylene glycol) moiety to the first silicon. For instance, the disiloxanes can be represented by Formula V, where R²¹ is Group I, and R¹² is a divalent organic moiety.

Where the first substituent is a side chain that includes an oligo(alkylene glycol) moiety, each of the entities linked to the second silicon can be alkyl groups and/or aryl groups. For instance, the second substituent can be an alkyl group or an aryl group. In some embodiments, the disiloxane is a compound of Formula V, where R²¹ is Group I, and R¹⁸ is an alkyl group or an aryl group.

Exemplary compounds of Formula V, include, but are not limited to:

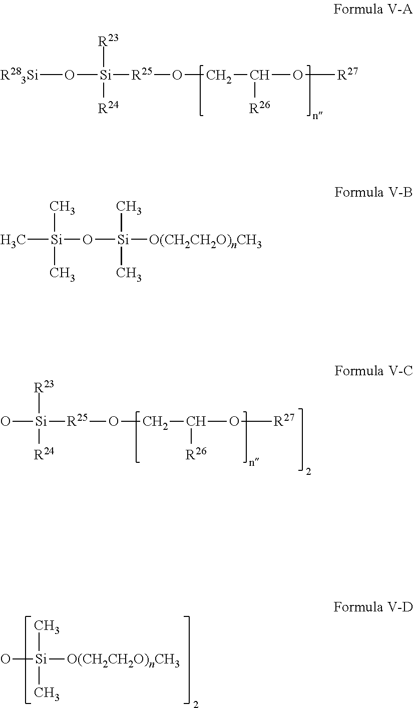

In the above compounds of Formulas V-A, V-B, V-C, and V-D, each R²³ and R²⁴ are individually an alkyl group or an aryl group; each R²⁵ is a bond or a divalent spacer; each R²⁶ is individually a hydrogen atom or an alkyl group; each R²⁷ is individually an alkyl group; each R²⁸ is individually an alkyl or an aryl group; n is an integer from 0 to 15, and n″ is an integer from 1 to 30. In some embodiments, n is an integer from 1 to 12. Where R²⁵ is a divalent spacer, it may be an organic divalent spacer, such as an alkylene, an alkylene glycol, or a bivalent ether group. For example, R²⁵ may be a moiety having one or more methylene groups. In some embodiments, R²⁵ is methylene, ethylene, propylene, or butylene. In one embodiment, R²⁵ is —(CH₂)₃—. In some embodiments, R²⁵ may be partially or completely halogenated. For instance, the above spacers can be completely or partially fluorinated. In some embodiments, each R²⁸ is individually an alkyl group. For example, each R²⁸ may individually be a methyl, ethyl, n-propyl, iso-propyl, n-butyl, iso-butyl, or tert-butyl group. In some embodiments, each R³¹ is a methyl group. In one embodiment, each R²⁸ is a methyl, R²⁵ is —(CH₂)₃—; and R²⁶ is a hydrogen. In one embodiment, each R²⁸ is a methyl; R²⁵ is —(CH₂)₃—; and R²⁶ is a hydrogen; and n is 3. In some embodiments, n is 3.

In some embodiments, the disiloxane compound is CH₃O(CH₂CH₂O)ₙSi(CH₃)₂OSi(CH₃)₂O(CH₃)₂SiO(CH₂CH₂O)ₙCH₃, CH₃O(CH₂CH₂O)_{n′}(CH₂)₃Si(CH₃)₂OSi(CH₃)₂O(CH₃)₂Si(CH₂)₃O(CH₃)₂Si(OCH₂CH₂)_{n′}OCH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O(CH₂CH₂O)ₙ(CH₃)Si[OSi(CH₃)₃]₂, R—OSi(CH₃)₂OSi(CH₃)₂O(CH₃)₂SiO—R, R—OSi(CH₃)₂OSi(CH₃)₂OSi(CH₃)₃, R—O(CH₂)₃Si(CH₃)₂OSi(CH₃)₂O(CH₃)₂Si(CH₂)₃O—R, R—O(CH₂)₃Si(CH₃)₂OSi(CH₃)₂O—Si(CH₃)₃; R—OSi(CH₃)₂OSi(CH₃)₂O(CH₃)₂SiO(CH₂CH₂)ₙCH₃, or R—O(CH₂)₃Si(CH₃)₂O—Si(CH₃)₂O(CH₃)₂Si(CH₂)₃O(CH₂CH₂)ₙCH₃, where n is 2, 3, 4, 5, 6, or 7; and R is a carbonate group. Specific examples may include, but are not limited to CH₃O(CH₂CH₂O)₂Si(CH₃)₂O(CH₃)₂SiO(CH₂CH₂O)₂CH₃, CH₃O(CH₂CH₂O)₃Si(CH₃)₂O(CH₃)₂SiO(CH₂CH₂O)3CH₃, CH3O(CH₂CH₂O)₄Si(CH₃)₂O(CH₃)₂SiO(CH₂CH₂O)₄CH₃, CH₃O(CH₂CH₂O)₅Si(CH₃)₂O(CH₃)₂SiO(CH₂CH₂O)₅CH₃, CH₃O(CH₂CH₂O)₆Si(CH₃)₂O(CH₃)₂SiO(CH₂CH₂O)₆CH₃, CH₃O(CH₂CH₂O)₇Si(CH₃)₂O(CH₃)₂SiO(CH₂CH₂O)₇CH₃; CH₃O(CH₂CH₂O)₂CH₂—Si(CH₃)₂O(CH₃)₂Si—CH₂O(CH₂CH₂O)₂CH₃, CH₃O(CH₂CH₂O)₂CH₂Si(CH₃)₃O(CH₃)₂Si—CH₂O(CH₂CH₂O)₃CH₃, CH₃O(CH₂CH₂O)₄CH₂Si(CH₃)₂O(CH₃)₂SiCH₂O(CH₂CH₂O)₄CH₃, CH₃O(CH₂CH₂O)₅CH₂Si(CH₃)₂O(CH₃)₂SiCH₂O(CH₂CH₂O)₅CH₃, CH₃O(CH₂CH₂O)₆CH₂—Si(CH₃)₂O(CH₃)₂SiCH₂O(CH₂CH₂O)₆CH₃, CH₃O(CH₂CH₂O)₇CH₂Si(CH₃)₂O(CH₃)₂Si—CH₂O(CH₂CH₂O)₇CH₃; CH₃O(CH₂CH₂O)₂(CH₂)₃Si(CH₃)₂O(CH₃)₂Si—(CH₂)₃O(CH₂CH₂O)₂CH₃, CH₃O(CH₂CH₂O)₃(CH₂)₃—Si(CH₃)₂O(CH₃)₂Si—(CH₂)₃O(CH₂CH₂O)₃CH₃, CH₃O(CH₂CH₂O)₄(CH₂)₃—Si(CH₃)₂O(CH₃)₂Si—(CH₂)₃O(CH₂CH₂O)₄CH₃, CH₃O(CH₂CH₂O)₅(CH₂)₃—Si(CH₃)₂O(CH₃)₂Si—(CH₂)₃O(CH₂CH₂O)₅CH₃, CH₃O(CH₂CH₂O)₆(CH₂)₃—Si(CH₃)₂O(CH₃)₂Si—(CH₂)₃O(CH₂CH₂O)₆CH₃, CH₃O(CH₂CH₂O)₇(CH₂)₃Si(CH₃)₂O(CH₃)₂Si—(CH₂)₃O(CH₂CH₂O)₇CH₃; (CH₃)₃SiO(CH₃)₂Si—(CH₂)₃O(CH₂CH₂O)₂CH₃, (CH₃)₃SiO(CH₃)₂Si—(CH₂)₃O(CH₂CH₂O)₃CH₃, (CH₃)₃SiO(CH₃)₂Si—(CH₂)₃O(CH₂CH₂O)₄CH₃, (CH₃)₃SiO(CH₃)₂Si—(CH₂)₃O(CH₂CH₂O)₅CH₃, (CH₃)₃SiO(CH₃)₂Si—(CH₂)₃O(CH₂CH₂O)₆CH₃, (CH₃)₃SiO(CH₃)₂Si—(CH₂)₃O(CH₂CH₂O)₇CH₃; (CH₃)₃SiO(CH₃)₂Si—(CH₂)₂O(CH₂CH₂O)₂CH₃, (CH₃)₃SiO(CH₃)₂Si—(CH₂)₂O(CH₂CH₂O)₃CH₃, (CH₃)₃SiO(CH₃)₂Si—(CH₂)₂O(CH₂CH₂O)₄CH₃, (CH₃)₃SiO(CH₃)₂Si—(CH₂)₂O(CH₂CH₂O)₅CH₃, (CH₃)₃SiO(CH₃)₂Si—(CH₂)₂O(CH₂CH₂O)₆CH₃, (CH₃)₃SiO(CH₃)₂Si—(CH₂)₂O(CH₂CH₂O)₇CH₃; (CH₃)₃SiO(CH₃)₂SiO(CH₂CH₂O)₂CH₃, (CH₃)₃SiO(CH₃)₂SiO(CH₂CH₂O)₃CH₃, (CH₃)₃SiO(CH₃)₂SiO(CH₂CH₂O)₄CH₃, (CH₃)₃SiO(CH₃)₂SiO(CH₂CH₂O)₅CH₃, (CH₃)₃SiO(CH₃)₂SiO(CH₂CH₂O)₆CH₃, and (CH₃)₃SiO(CH₃)₂SiO(CH₂CH₂O)₇CH₃.

In some embodiments, the non-aqueous electrolyte solvent includes a trisiloxane compound. Some such trisiloxanes may be represented by general Formula VI:

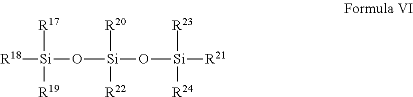

where R¹⁷, R¹⁹, R²⁰, R²¹, R²³ and R²⁴ are individually an alkyl group or an aryl group; R¹⁰ is an alkyl group, an aryl group, an oligo(alkylene glycol) group, or an alkylcyclic carbonate group; and R²¹ is an alkyl group, an aryl group, an oligo(alkylene glcycol) group, or an alkylcyclic carbonate group. In some embodiments, R¹⁸ is selected from Group I, Group II, or Group III. In other embodiments, R²¹ is an alkyl group, an aryl group, Group I, or Group III. In some embodiments, R²¹ is selected from Group I or Group III. In some embodiments, R¹⁸ is selected from an alkyl group, an aryl group, or Group I. In other embodiments, R¹⁸ is an alkyl, an aryl, or Group III. In some embodiments, R¹⁷, R¹⁹, R²⁰, R²¹, R²³ and R²⁴ are individually an alkyl group. For example, R¹⁷, R¹⁹, R²⁰, R²¹, R²³ and R²⁴ may individually a methyl, ethyl, n-propyl, iso-propyl, n-butyl, iso-butyl, or tert-butyl group. In some embodiments, R¹⁷, R¹⁹, R²⁰, R²¹, R²³ and R²⁴ are each a methyl group.

Representative trisiloxanes of Formula VI include, but are not limited to, those compounds described by Formulas VI-A, VI-B, VI-C, and VI-D.

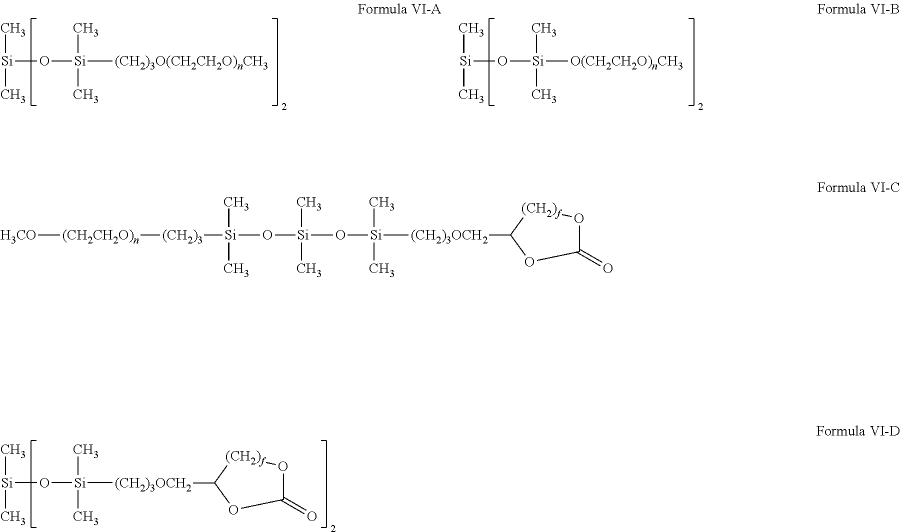

In each of the formulas, each n is independently an integer from 1 to 12 and f is 1 or 2.

In each of Formulas VI-A and VI-B, a trisiloxane having terminal silicon atoms linked to a side chain that includes a poly(ethylene oxide) moiety are shown. Formula VI-A illustrates an organic spacer positioned between each poly(ethylene oxide) moiety and the terminal silicon. Formula VI-B illustrates each of the terminal silicon atoms linked directly to a poly(ethylene oxide) moiety. In each of Formulas VI-C and VI-D a trisiloxane with a terminal silicon linked to a side chain that includes a cyclic carbonate moiety are shown. Formula VI-C illustrates one of the terminal silicon atom linked to a side chain that includes a cyclic carbonate moiety and one of the terminal silicon atoms linked to a side chain that includes a poly(ethylene oxide) moiety. Formula VI-D illustrates each of the terminal silicon atoms linked to a side chain that includes a cyclic carbonate moiety.

In other embodiments, the trisiloxanes are compounds according to Formula VII.

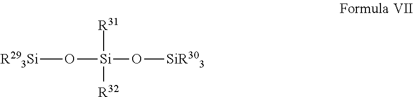

where each R²⁹, R³⁰, and R³¹ are individually an alkyl group or an aryl group; and R³² is selected from Group I, Group II, or Group III.

Representative compounds of Formula VII include, but are not limited to compounds such as those of Formulas VII-A, VII-B, VII-C and VII-D.

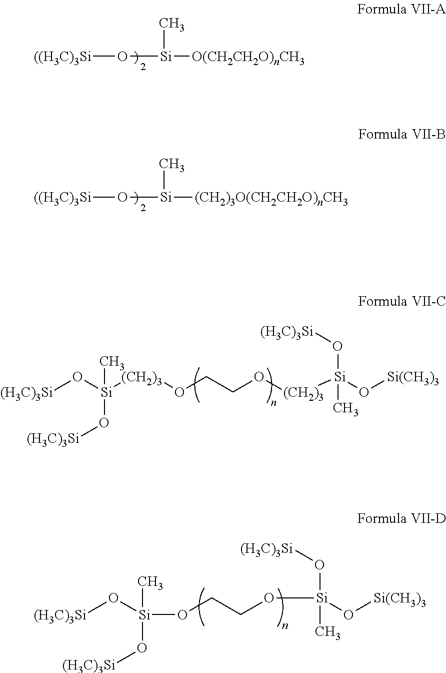

In each of the formulas, each n is independently an integer from 1 to 12.

Formula VII-A illustrates a trisiloxane where the central silicon atom is directly linked to a side chain that includes a poly(ethylene oxide). Formulas VII-C and VII-D illustrate trisiloxanes having a central silicon atom linked through a cross-link (e.g. the poly(alkylene oxide) moiety) joining the trisiloxane to a second trisiloxane. Formula VII-C illustrates the cross-link including a spacer positioned between the poly(alkylene oxide) moiety and each of the trisiloxanes. Formula VII-D illustrates a silicon atom in the backbone of each trisiloxane linked directly to a poly(alkylene oxide) moiety.

In some embodiments, the trisiloxane is CH₃O(CH₂CH₂O)₂Si(CH₃)₂OSi(CH₃)₂O(CH₃)₂SiO(CH₂CH₂O)₂CH₃, CH₃O(CH₂CH₂O)₃Si(CH₃)₂OSi(CH₃)₂O(CH₃)₂SiO(CH₂CH₂O)₃CH₃, CH₃O(CH₂CH₂O)₄Si(CH₃)₂OSi(CH₃)₂O(CH₃)₂SiO(CH₂CH₂O)₄CH₃, CH₃O(CH₂CH₂O)₅Si(CH₃)₂OSi(CH₃)₂O(CH₃)₂SiO(CH₂CH₂O)₅CH₃, CH₃O(CH₂CH₂O)₆Si(CH₃)₂OSi(CH₃)₂O(CH₃)₂SiO(CH₂CH₂O)₆CH₃, CH₃O(CH₂CH₂O)₇Si(CH₃)₂OSi(CH₃)₂O(CH₃)₂SiO(CH₂CH₂O)₇CH₃; CH₃O(CH₂CH₂O)₂(CH₂)₃Si(CH₃)₂OSi(CH₃)₂O(CH₃)₂Si(CH₂)₃O(CH₃)₂SiO(CH₂CH₂O)₂CH₃, CH₃O(CH₂CH₂O)₃(CH₂)₃Si(CH₃)₂OSi(CH₃)₂O(CH₃)₂Si(CH₂)₃O(CH₃)₂SiO(CH₂CH₂O)₃CH₃, CH₃O(CH₂CH₂O)₄(CH₂)₃Si(CH₃)₂OSi(CH₃)₂O(CH₃)₂Si(CH₂)₃O(CH₃)₂SiO(CH₂CH₂O)₄CH₃, CH₃O(CH₂CH₂O)₅(CH₂)₃Si(CH₃)₂OSi(CH₃)₂O(CH₃)₂Si(CH₂)₃O(CH₃)₂SiO(CH₂CH₂O)₅CH₃; [(CH₃)₃SiO]₂Si(CH₃)O(CH₂CH₂O)₂CH₃, [(CH₃)₃SiO]₂Si(CH₃)O(CH₂CH₂O)₃CH₃, [(CH₃)₃SiO]₂Si(CH₃)O(CH₂CH₂O)₄CH₃, [(CH₃)₃SiO]₂Si(CH₃)O(CH₂CH₂O)₅CH₃, [(CH₃)₃SiO]₂Si(CH₃)O(CH₂CH₂O)₆CH₃, [(CH₃)₃SiO]₂Si(CH₃)O(CH₂CH₂O)₇CH₃; [(CH₃)₃SiO]₂Si(CH₃)(CH₂)₃O(CH₂CH₂O)₂CH₃, [(CH₃)₃SiO]₂Si(CH₃)(CH₂)₃O(CH₂CH₂O)₃CH₃, [(CH₃)₃SiO]₂Si(CH₃)(CH₂)₃O(CH₂CH₂O)₄CH₃, [(CH₃)₃SiO]₂Si(CH₃)(CH₂)₃O(CH₂CH₂O)₅CH₃, [(CH₃)₃SiO]₂Si(CH₃)(CH₂)₃O(CH₂CH₂O)₆CH₃, [(CH₃)₃SiO]₂Si(CH₃)(CH₂)₃O(CH₂CH₂O)₇CH₃; [(CH₃)₃SiO]₂Si(CH₃)O(CH₂CH₂O)₂(CH₃)Si[OSi(CH₃)₃]₂, [(CH₃)₃SiO]₂Si(CH₃)O(CH₂CH₂O)₃(CH₃)Si[OSi(CH₃)₃]₂, [(CH₃)₃SiO]₂Si(CH₃)O(CH₂CH₂O)₄(CH₃)Si[OSi(CH₃)₃]₂, [(CH₃)₃SiO]₂Si(CH₃)O(CH₂CH₂O)₅(CH₃)Si[OSi(CH₃)₃]₂, [(CH₃)₃SiO]₂Si(CH₃)O(CH₂CH₂O)₆(CH₃)Si[OSi(CH₃)₃]₂, [(CH₃)₃SiO]₂Si(CH₃)O(CH₂CH₂O)₇(CH₃)Si[OSi(CH₃)₃]₂; R—OSi(CH₃)₂OSi(CH₃)₂O(CH₃)₂SiO—R, R—OSi(CH₃)₂OSi(CH₃)₂OSi(CH₃)₃, RO(CH₂)₃Si(CH₃)₂OSi(CH₃)₂O(CH₃)₂Si(CH₂)₃O—R, RO(CH₂)₃Si(CH₃)₂OSi(CH₃)₂OSi(CH₃)₃; R—OSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃, where n is 2, 3, 4, 5, 6, or 7, and R is a carbonate group.

In some embodiments, the fluorinated ester is a fluorinated carbonate of general Formula II:

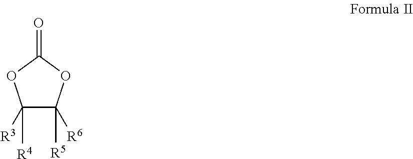

In Formula II, R³ is a fluorine-containing alkyl group, a fluorine-containing alkoxyl group or a fluorine-containing ether group with two or more carbon atoms; R⁴ and R⁵ are individually H, F, Cl, CF₃ or CH₃; and R⁶ is H, F, Cl or an alkyl group. In some embodiments, R³ is a C₁-C₅ alkyl group having at least one F, and that is optionally further substituted with one or more Cl. For example, R³ may include, but is not limited to, the following groups CF₃, CF₃CH₂—, CF₃CF₂—, CF₃CH₂CH₂—, CF₃CF₂CH₂—, CF₃CF₂CF₂—, CF₃CH₂CF₂—, CF₃CH₂CH₂CH₂—, CF₃CF₂CH₂CH₂—, CF₃CH₂CF₂CH₂—, CF₃CF₂CF₂CH₂—, CF₃CF₂CF₂CF₂—, CF₃CF₂CH₂CF₂—, CF₃CH₂CH₂CH₂CH₂—, CF₃CF₂CH₂CH₂CH₂—, CF₃CH₂CF₂CH₂CH₂—, CF₃CF₂CF₂CH₂CH₂—, CF₃CF₂CF₂CF₂CH₂—, CF₃CF₂CH₂CF₂CH₂—, CF₃CF₂CH₂CH₂CH₂CH₂—, CF₃CF₂CF₂CF₂CH₂CH₂—, CF₃CF₂CH₂CF₂CH₂CH₂—, HCF₂—, HCF₂CH₂—, HCF₂CF₂—, HCF₂CH₂CH₂—, HCF₂CF₂CH₂—, HCF₂CH₂CF₂—, HCF₂CF₂CH₂CH₂—, HCF₂CH₂CF₂CH₂—, HCF₂CF₂CF₂CF₂—, HCF₂CF₂CH₂CH₂CH₂—, HCF₂CH₂CF₂CH₂CH₂—, HCF₂CF₂CF₂CF₂CH₂—, HCF₂CF₂CF₂CF₂CH₂CH₂—, FCH₂—, FCH₂CH₂—, FCH₂CF₂—, FCH₂CF₂CH₂—, FCH₂CF₂CF₂—, CH₃CF₂CH₂—, CH₃CF₂CF₂—, CH₃CH₂CH₂—, CH₃CF₂CH₂CF₂—, CH₃CF₂CF₂CF₂—, CH₃CH₂CF₂CF₂—, CH₃CF₂CH₂CF₂CH₂—, CH₃CF₂CF₂CF₂CH₂—, CH₃CF₂CF₂CH₂CH₂—, CH₃CH₂CF₂CF₂CH₂—, CH₃CF₂CH₂CF₂CH₂—, CH₃CF₂CH₂CF₂CH₂CH₂—, CH₃CF₂CH₂CF₂CH₂CH₂—, HCFClCF₂CH₂—, HCF₂CFClCH₂, HCF₂CFClCF₂CFClCH₂— or HCFClCF₂CFClCF₂CH₂—.

In some embodiments, the fluorinated ester is a fluorinated carbonate of general Formula III:

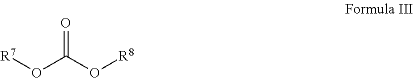

In Formula III, R⁷ and R⁸ are individually a fluorine-containing C₁ to C₈ alkyl group, a fluorine-containing C₁ to C₈ alkoxyl group or a fluorine-containing C₁ or C₂ ether group. In some embodiments, the compound of Formula III is [H(CF₂)₂CH₂]₂CO₃; HF₂CCF₂CH₂OC(O)OCH₂CF₂CH₂F; HF₂CCF₂CH₂OC(O)OCH₂CH₂CF₂CF₂H; FH₂CCF₂CH₂OC(O)OCH₂CF₂CF₂H; [FCH₂CF₂CH₂]₂CO₃; FCH₂CF₂CH₂OC(O)OCH₂CH₂CF₂CF₂H; HF₂CCF₂CH₂CH₂OC(O)OCH₂CF₂CF₂H; HF₂CCF₂CH₂CH₂OC(O)OCH₂CF₂CH₂F; [HF₂CCF₂CH₂CH₂]₂CO₃; CF₃CF₂CH₂OC(O)OCH₂CF₂CF₂H; CF₃CF₂CH₂OC(O)OCH₂CF₂CH₂F; CF₃CF₂CH₂OC(O)OCH₂CH₂CF₂CF₂H; CF₃CH₂CH₂OC(O)OCH₂CF₂CF₂H; CF₃CH₂CH₂OC(O)OCH₂CF₂CH₂F; CF₃CH₂CH₂OC(O)OCH₂CH₂CF₂CF₂H; (CF₃)₂CFCH₂CH₂OC(O)OCH₂CF₂CF₂H; (CF₃)₂CFCH₂CH₂OC(O)OCH₂CF₂CH₂F; and (CF₃)₂CFCH₂CH₂OC(O)OCH₂CH₂CF₂CF₂H.

In some embodiments, the non-aqueous electrolyte solvent includes a fluorinated ether with the general Formula VII: R⁹OR¹⁰. R⁹ and R¹⁰ may be a fluorine-containing C₁-C₈ alkyl group, a fluorine-containing C₁-C₈ alkoxyl group or a fluorine-containing C₁ or C₂ ether group. Where R⁹ and R¹⁰ are the same a symmetrical ether is formed. Where R⁹ and R¹⁰ are different an asymmetrical ether is formed. In some embodiments, the fluorinated ether is F₃CCHFCF₂OCH₃; F₃CCHFCF₂OCH₂F; F₃CCHFCF₂OCF₂H; F₃CCHFCF₂OCF₃; (CF₃)₂CHCF₂OCH₃; (CF₃)₂CHCF₂OCH₂F; (CF₃)₂CHCF₂OCHF₂; (CF₃)₂CHCF₂OCF₃; F₃CFC═CFOCH₃; F₃CFC═CFOCH₂F; F₃CFC═CFOCHF₂; F₃CFC═CFOCF₃; F₂C═CFCF₂OCH₃; F₂C═CFCF₂OCH₂F; F₂C═CFCF₂OCF₂H; F₂C═CFCF₂OCF₃; (CF₃)₂C═CFOCH₃; (CF₃)₂C═CFOCH₂F; (CF₃)₂C═CFOCF₂H; (CF₃)₂C═CFOCF₃; F₂C═C(CF₃)CF₂OCH₃; F₂C═C(CF₃)CF₂OCH₂F; F₂C═C(CF₃)CF₂OCF₂H; or F₂C═C(CF₃)CF₂OCF₃.

According to some embodiments, an RTIL may be included in the non-aqueous electrolyte. Suitable RTILs include that that are based upon imidazolium salts, which include, but are not limited to, disubstituted imidazolium, trisubstituted imidazolium, functionalized imidazolium, and protonated imidazolium; pyridinium salts which include, but are not limited to, unsubstituted pyridinium, substituted pyridinium, and functionalized pyridinium; ammonium salts which include, but are not limited to, symmetrical ammoniums, unsymmetrical ammoniums, functionalized ammoniums, protonated ammoniums, and cholines; and phosphonium salts which include, but are not limited to, symmetrical phosphoniums, and unsymmetrical phosphoniums. Other RTILs may be readily understood by the person of ordinary skill in the art. In other embodiments, an anion of the RTILs are selected from [CF₃CO₂]⁻; [C₂F₅CO₂]⁻; [ClO₄]⁻; [BF₄]⁻; [AsF₆]⁻; [PF₆]⁻; [PF₂(C₂O₄)₂]⁻; [PF₄C₂O₄]⁻; [CF₃SO₃]⁻; [N(CF₃SO₂)₂]⁻; [C(CF₃SO₂)₃]⁻; [N(SO₂C₂F₅)₂]⁻; alkyl fluorophosphates; [B(C₂O₄)₂]⁻; [BF₂C₂O₄]⁻; [B₁₂X₁₂₋ₖHₖ]²⁻; and [B₁₀X_{10-k′}H_{k′}]²⁻.

Suitable RTILs include, but are not limited to, 1-ethyl-3-methylimidazolium bis(trifluoromethylsulfonyl)imide, 1-ethyl-3-methylimidazolium bis[oxalato]borate, 1-ethyl-3-methylimidazolium hexafluorophosphate, 1-ethyl-3-methylimidazolium hexafluoroantimonate, 1-benzyl-3-methylimidazolium tetrafluoroborate, 1-benzyl-3-methylimidazolium hexafluorophosphate, 1-butyl-3-methylimidazolium bis(trifluoromethylsulfonyl)imide, 1-butyl-3-methylimidazolium hexafluorophosphate, 1-butyl-3-methylimidazolium tetrafluoroborate, 1-hexyl-3-methylimidazolium bis(trifluoromethylsulfonyl)imide, 1-hexyl-3-methylimidazolium hexafluorophosphate, 1-hexyl-3-methylimidazolium tetrafluoroborate, 1-methyl-3-octylimidazolium bis(trifluoromethylsulfonyl)imide, 1-methyl-3-octylimidazolium hexafluorophosphate, 1-methyl-3-octylimidazolium tetrafluoroborate, tetraethylammonium tetrafluoroborate, tetraethylammonium trifluoromethanesulfonate, tetrahexylammonium tetrafluoroborate, tetramethylammonium bis(oxalato(2-))-borate, butyltrimethylammonium bis(trifluoromethylsulfonyl)imide, butyltrimethylammonium hexafluorophosphate, butyltrimethylammonium tetrafluoroborate, cyclohexyltrimethylammonium bis(trifluoromethylsulfonyl)imide, ethyl-dimethyl-propylammonium bis(trifluoromethylsulfonyl)imide, hexyltrimethylammonium bis(trifluoromethylsulfonyl)imide, hexyltrimethylammonium hexafluorophosphate, hexyltrimethylammonium tetrafluoroborate, tributylmethylammonium bis(trifluoromethylsulfonyl)imide, trimethylpropylammonium bis(trifluoromethylsulfonyl)imide, tetrabutylphosphonium tetrafluoroborate, tributyl(2-methoxyethyl)phosphonium bis(trifluoromethylsulfonyl)imide, trihexyl(tetradecyl)phosphonium bis(trifluoromethylsulfonyl)imide, trihexyl(tetradecyl)phosphonium bis[oxalato(2-)]borate, trihexyl(tetradecyl)phosphonium tetrafluoroborate, trihexyl(tetradecyl)phosphonium hexafluorophosphate, N-butylpyridinium hexafluorophosphate, N-butylpyridinium hexafluoroantimonate, N-butylpyridinium perchlorate, N-butylpyridinium tetrafluoroborate, N-butylpyridinium trifluoromethanesulfonate, N-ethylpyridinium tetrafluoroborate, N-hexylpyridinium bis(trifluoromethylsulfonyl)imide, N-hexylpyridinium hexafluorophosphate, N-hexylpyridinium tetrafluoroborate, and N-hexylpyridinium trifluoromethanesulfonate.

In some embodiments, the non-aqueous electrolyte solvent includes an organic phosphate compound:

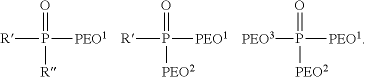

In such embodiments, R′ and R″ are independently a substituted or unsubstituted alkyl group having from 1 to 12 carbon atoms, a substituted or unsubstituted alkenyl group having from 2 to 12 carbon atoms, or an oligo(ethylene glycol) chain; and PEO¹, PEO² and PEO³ each independently an oligo(ethylene glycol) group.

In some other embodiment, carbonate-based or glyme-based compounds are added to the above mixed electrolyte solvents to further reduce the viscosity. Typically, these aprotic solvents are anhydrous. Examples of aprotic solvents or carriers for forming the electrolyte systems include dimethyl carbonate, ethyl methyl carbonate, diethyl carbonate, methyl propyl carbonate, ethyl propyl carbonate, dipropyl carbonate, dimethoxyethane, triglyme, propylene carbonate, dimethylvinylene carbonate, tetraethyleneglycol, dimethyl ether, polyethylene glycols, and γ-butyrolactone. In some embodiments, the aprotic solvent or carrier is propylene carbonate or ethylene carbonate. In other embodiments, the aprotic solvent or carrier is propylene carbonate.

In some other embodiment, the non-aqueous electrolyte solvent includes an organic carbonate solvent. Typically, the aprotic solvents are anhydrous. Illustrative examples of aprotic solvents or carriers include, but are not limited to, propylene carbonate, ethylene carbonate, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, and γ-butyrolactone. In some embodiments, the solvent is propylene carbonate or ethylene carbonate. In some embodiments, the solvent is propylene carbonate.

In some embodiments, the non-aqueous electrolyte includes a sulfone and a siloxane or silane. In some embodiments, the non-aqueous electrolyte includes a sulfones and a fluorinated ether or fluorinated ester. In some embodiments, the non-aqueous electrolyte includes a sulfones and a room temperature ionic liquid. In some embodiments, the non-aqueous electrolyte includes a siloxane or silane and a fluorinated ether or fluorinated ester. In some embodiments, the non-aqueous electrolyte includes a siloxane or silane and a room temperature ionic liquid. In some embodiments, the non-aqueous electrolyte includes a fluorinated ether or fluorinated ester and a room temperature ionic liquid. In any such embodiments in this paragraph, the non-aqueous electrolyte may also include a carbonate solvent.

In one aspect, the non-aqueous electrolyte contains a binary electrolyte solvent that is prepared by combining any two of a sulfone solvent, a siloxane or silane solvent, a fluorinated ether or ester solvent, a RTIL, and an organic phosphate compound. In another aspect, the non-aqueous electrolyte contains a tertiary electrolyte solvent by that is prepared by combining three or more of a sulfone solvent, a siloxane or silane solvent, a fluorinated ether or ester solvent, a RTIL, and an organic phosphate compound. In another aspect, the non-aqueous electrolyte contains a quaternary electrolyte solvent by that is prepared by combining four or more of a sulfone solvent, a siloxane or silane solvent, a fluorinated ether or ester solvent, a RTIL, and an organic phosphate compound. In some embodiments, the non-aqueous electrolyte contains at least one sulfone. In some embodiments, the non-aqueous electrolyte contains at least one silane or siloxane. In some embodiments, the non-aqueous electrolyte contains at least one fluorinated ether or fluorinated ester. In some embodiments, the non-aqueous electrolyte contains at least one RTIL. In some embodiments, the non-aqueous electrolyte contains at least one organic phosphate compound. In some embodiments, the non-aqueous electrolyte contains at least one sulfone and at least one silane or siloxane. In some embodiments, the non-aqueous electrolyte contains at least one sulfone and at least one fluorinated ether or fluorinated ester. In yet another aspect, the non-aqueous electrolyte may additionally contain other appropriate electrolyte solvents such as other ionic liquids, conventional carbonate solvents, and other solvents as are known to those of skill in the art.

In some embodiments, the non-aqueous electrolyte includes one or more ionic electrolyte salts of the formula M^{a+}X^{b-}, where M^{a+} is an electrochemically stable cation and X^{b-} is an electrochemically stable anion. For example, M^{a+} may be H⁺, an alkali metal ion, an alkaline earth metal ion, a tetraalkylammonium ion, or an imidazolium ion, or a mixture of any two or more thereof. For example, M^{a+} may be Li⁺, Na⁺, Ca²⁺, Mg²⁺, tetraethylammonium, tetramethylammonium, or imidazolium onium. X^{b-} may be [CF₃CO₂]⁻; [C₂F₅CO₂]⁻; [ClO₄]⁻; [BF₄]⁻; [AsF₆]⁻; [PF₆]⁻; [PF₂(C₂O₄)₂]⁻; [PF₄C₂O₄]⁻; [CF₃SO₃]⁻; [N(CF₃SO₂)₂]⁻; [C(CF₃SO₂)₃]⁻; [N(SO₂C₂F₅)₂]⁻; alkyl fluorophosphates; [B(C₂O₄)₂]⁻; [BF₂C₂O₄]⁻; [B₁₂X₁₂₋ₖHₖ]²⁻; and [B₁₀X_{10-k′}H_{k′}]²⁻; where X is OH, F, Cl, or Br; k is an integer from 0 to 12; and k′ is an integer from 0 to 10. In some embodiments, the ionic electrolyte salt includes Li[CF₃CO₂]; Li[C₂F₅CO₂]; Li[ClO₄]; Li[BF₄]; Li[AsF₆]; Li[PF₆]; Li[PF₂(C₂O₄)₂]; Li[PF₄C₂O₄]; Li[CF₃SO₃]; Li[N(CF₃SO₂)₂]; Li[C(CF₃SO₂)₃]; Li[N(SO₂C₂F₅)₂]; lithium alkyl fluorophosphates; Li[B(C₂O₄)₂]; Li[BF₂C₂O₄]; Li₂[B₁₂X₁₂₋ₙHₙ]; or Li₂[B₁₀X₁₀₋ₙHₙ].

In some embodiments, the ionic electrolyte salt is present from about 0.01 M to about 1.5 M, from about 0.05 M to about 1.2 M, or from about 0.4 M to about 1.0 M. If the concentration of the ionic electrolyte salt is less than about 0.01 M, the ionic conductivity of the resulting non-aqueous electrolyte tends to decrease due to an inadequate number of carrier ions in the electrolyte.

In some embodiments, an electrode stabilizing additive is added to the electrolyte. As used herein, an electrode stabilizing additive is used to refer to a compound that forms a stable passivation film on the surface of the anode. The electrode stabilizing additives either reduce or polymerize at the surface of the anode to form a stable SEI layer.

In some embodiments, suitable electrode stabilizing additives include, but are not limited to 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2 amino-3 vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2 vinyloxetane, 2-vinyloxy-cyclopropanone, 3-(N-vinylamino)cyclohexanone, 3,5-divinyl furoate, 3-vinylazetidin-2-one, 3 vinylaziridin 2 one, 3 vinylcyclobutanone, 3 vinylcyclopentanone, 3 vinyloxaziridine, 3 vinyloxetane, 3-vinylpyrrolidin-2-one, 4,4 divinyl-3 dioxolan 2-one, 4 vinyltetrahydropyran, 5-vinylpiperidin-3-one, allylglycidyl ether, butadiene monoxide, butyl vinyl ether, dihydropyran-3-one, divinyl butyl carbonate, divinyl carbonate, divinyl crotonate, divinyl ether, divinyl ethylene carbonate, divinyl ethylene silicate, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone, or a mixture of any two or more thereof. In some embodiments the electrode stabilizing additive may be a cyclotriphosphazene that is substituted with F, alkyloxy, alkenyloxy, aryloxy, methoxy, allyloxy groups, or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)-cyclotriphosphazene, (diaryloxy)(trifluoro)(methoxy)cyclotriphosphazene compounds, or a mixture of two or more such compounds. In some embodiments, the electrode stabilizing additive is vinyl ethylene carbonate, vinyl carbonate, or 1,2-diphenyl ether.

In other embodiments, the electrode stabilizing additives include compounds with phenyl, naphthyl, anthracenyl, pyrrolyl, oxazolyl, furanyl, indolyl, carbazolyl, imidazolyl, or thiophenyl groups. For example, electrode stabilizing additives may be aryloxpyrrole, aryloxy ethylene sulfate, aryloxy pyrazine, aryloxy-carbazole trivinylphosphate, aryloxy-ethyl-2-furoate, aryloxy-o-terphenyl, aryloxy-pyridazine, butyl-aryloxy-ether, divinyl diphenyl ether, (tetrahydro-furan-2-yl)-vinylamine, divinyl methoxybipyridine, methoxy-4-vinylbiphenyl, vinyl methoxy carbazole, vinyl methoxy piperidine, vinyl methoxypyrazine, vinyl methyl carbonate-allylanisole, vinyl pyridazine, 1-divinylimidazole, 3-vinyltetrahydrofuran, divinyl furan, divinyl methoxy furan, divinylpyrazine, vinyl methoxy imidazole, vinylmethoxy pyrrole, vinyl-tetrahydrofuran, 2,4-divinyl isooxazole, 3,4 divinyl-1-methylpyrrole, aryloxyoxetane, aryloxy-phenyl carbonate, aryloxy-piperidine, aryloxy-tetrahydrofuran, 2-aryl-cyclopropanone, 2-diaryloxy-furoate, 4-allylanisole, aryloxy-carbazole, aryloxy-2-furoate, aryloxy-crotonate, aryloxy-cyclobutane, aryloxy-cyclopentanone, aryloxy-cyclopropanone, aryloxy-cyclolophosphazene, aryloxy-ethylene silicate, aryloxy-ethylene sulfate, aryloxy-ethylene sulfite, aryloxy-imidazole, aryloxy-methacrylate, aryloxy-phosphate, aryloxy-pyrrole, aryloxyquinoline, diaryloxycyclotriphosphazene, diaryloxy ethylene carbonate, diaryloxy furan, diaryloxy methyl phosphate, diaryloxy-butyl carbonate, diaryloxy-crotonate, diaryloxy-diphenyl ether, diaryloxy-ethyl silicate, diaryloxy-ethylene silicate, diaryloxy-ethylene sulfate, diaryloxyethylene sulfite, diaryloxy-phenyl carbonate, diaryloxy-propylene carbonate, diphenyl carbonate, diphenyl diaryloxy silicate, diphenyl divinyl silicate, diphenyl ether, diphenyl silicate, divinyl methoxydiphenyl ether, divinyl phenyl carbonate, methoxycarbazole, or 2,4-dimethyl-6-hydroxy-pyrimidine, vinyl methoxyquinoline, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o terphenyl, N-methylpyrrole, or naphthalene.

In yet other embodiments, the electrode stabilizing additives include substituted or unsubstituted spirocyclic hydrocarbons containing at least one oxygen atom and at least one alkenyl or alkynyl group. For example, such stabilizing additives include those having Formula VIII:

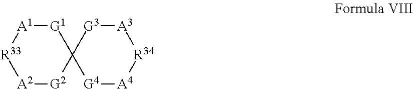

wherein A¹, A², A³, and A⁴ are independently O or CR³⁵R³⁶; provided that A¹ is not O when G¹ is O, A² is not O when G² is O, A³ is not O when G³ is O, and A⁴ is not O when G⁴ is O; G¹, G², G³, and G⁴ are independently O or CR³⁵R³⁶; provided that G¹ is not O when A¹ is O, G² is not O when A² is O, G³ is not O when A³ is O, and G⁴ is not O when A⁴ is O; R³³ and R³⁴ are independently a substituted or unsubstituted divalent alkenyl or alkynyl group; and R³⁵ and R³⁶ at each occurrence are independently H, F, Cl, or a substituted or an unsubstituted alkyl, alkenyl, or alkynyl group.

Representative examples of Formula VIII include, but are not limited to, 3,9 divinyl-2,4,8,10-tetraoxaspiro[5.5]undecane, 3,9-divinyl-2,4,8-trioxaspiro[5.5]undecane, 3,9-divinyl-2,4-dioxaspiro[5.5]undecane, 3,9-diethylidene-2,4,8,10-tetraoxaspiro[5.5]undecane, 3,9 diethylidene-2,4,8-trioxaspiro[5.5]undecane, 3,9-diethylidene-2,4-dioxaspiro[5.5]undecane, 3,9-dimethylene-2,4,8,10-tetraoxaspiro[5.5]undecane, 3,9-divinyl-1,5,7,11-tetraoxaspiro[5.5]undecane, 3,9 dimethylene-1,5,7,11-tetraoxaspiro[5.5]undecane, 3,9 diethylidene-1,5,7,11-tetraoxaspiro[5.5]undecane, or a mixture of any two or more such compounds. Furthermore, mixtures of any two or more electrode stabilizing additives may also be used in the electrolytes of the present invention.

In some embodiments, the electrode stabilizing additive is an anion receptor. Anion receptors may include, but are not limited to, compounds such as tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, or a mixture of any two or more thereof. Further suitable additives include 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl) pentafluorophenylboronate, or a mixture of any two or more such compounds.

In some instances, the concentration of the electrode stabilizing additive in the electrolyte generally does not greatly exceed the concentration needed to form the passivation layer. As a result, the additives are generally present in smaller concentrations than the ionic electrolyte salts. A suitable concentration for an additive in the electrolyte includes, but is not limited to, concentrations greater than about 0.1 wt %, greater than about 0.5 wt % and/or less than about 5 wt %, less than about 20 wt %, or less than about 35 wt % where each of the wt % refers to the percentage of the total weight of solvent plus additive. In some embodiments, the concentration of the additive is less than about 3 wt %, or less than about 2 wt %. In yet other embodiments, a concentration of the electrolyte additive is from about 0.1 wt % to about 35 wt %, from about 0.1 wt % to about 30 wt %, from about 0.1 wt % to about 25 wt %, from about 0.1 wt % to about 20 wt %, from about 0.1 wt % to about 10 wt %, from about 0.1 wt % to about 5 wt %, from about 0.1 wt % to about 3 wt %, from about 0.1 wt % to about 2 wt %, from about 0.1 wt % to about 1 wt %, from about 0.5 wt % to about 10 wt %, from about 0.5 wt % to about 3 wt %, or from about 0.5 wt % to about 2 wt %.

In another aspect, the non-aqueous electrolyte includes an aprotic gel polymer carrier/solvent. Suitable gel polymer carrier/solvents include polyethers, polyethylene oxides, polyimides, polyphosphazines, polyacrylonitriles, polysiloxanes, polyether grafted polysiloxanes, derivatives of the foregoing, copolymers of the foregoing, crosslinked and network structures of the foregoing, blends of the foregoing, and the like, to which is added an appropriate ionic electrolyte salt. Other gel-polymer carrier/solvents include those prepared from polymer matrices derived from polypropylene oxides, polysiloxanes, sulfonated polyimides, perfluorinated membranes (Nafion™ resins), divinyl polyethylene glycols, polyethylene glycol-bis-(methyl acrylates), polyethylene glycol-bis(methyl methacrylates), derivatives of the foregoing, copolymers of the foregoing, crosslinked and network structures of the foregoing.

In yet another aspect, an electrochemical device is provided that includes a cathode; an anode; and a non-aqueous electrolyte. In one embodiment, the electrochemical device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical cell is a capacitor. In some embodiments, the capacitor is an asymmetric capacitor or supercapacitor. In some embodiments, the electrochemical cell is a primary cell. In some embodiments, the primary cell that is a lithium/MnO₂ battery or Li/poly(carbon monofluoride) battery. In some embodiments, the electrochemical cell is a solar cell.

Suitable cathodes include those such as, but not limited to, a lithium metal oxide, spinel, olivine, carbon-coated olivine, LiFePO₄, LiCoO₂, LiNiO₂, LiNi₁₋ₓCo_{y}Met_{z}O₂, LiMn_{0.5}Ni_{0.5}O₂, LiMn_{0.3}Co_{0.3}Ni_{0.3}O₂, LiMn₂O₄, LiFeO₂, Li_{1+x′}Ni_{α}Mn_{β}Co_{γ}Met′_{δ}O_{2-z′}F_{z′}, A_{n′}B₂(XO₄)₃ (NASICON), vanadium oxide; lithium peroxide, sulfur, polysulfide, a lithium carbon monofluoride (also known as LiCFx), or mixtures of any two or more thereof, where Met is Al, Mg, Ti, B, Ga, Si, Mn, or Co; Met′ is Mg, Zn, Al, Ga, B, Zr, or Ti; A is Li, Ag, Cu, Na, Mn, Fe, Co, Ni, Cu, or Zn; B is Ti, V, Cr, Fe, or Zr; X is P, S, Si, W, or Mo; 0≦x≦0.3, 0≦y≦0.5, 0≦z≦0.5; 0≦x′≦0.4, 0≦α≦1, 0≦β≦1, 0≦γ≦1, 0≦δ≦0.4, and 0≦z′≦0.4; and 0≦n′≦3. According to some embodiments, the spinel is a spinel manganese oxide with the formula of Li₁₊ₓMn_{2-z}Met′″_{y}O₄₋ₘX′ₙ, wherein Met′″ is Al, Mg, Ti, B, Ga, Si, Ni, or Co; X′ is S or F; and wherein 0≦x≦0.3, 0≦y≦0.5, 0≦z≦0.5, 0≦m≦0.5 and 0≦n≦0.5. In other embodiments, the olivine has a formula of Li₁₊ₓFe_{1-z}Met″_{y}PO₄₋ₘX′ₙ, wherein Met″ is Al, Mg, Ti, B, Ga, Si, Ni, Mn or Co; X′ is S or F; and wherein 0≦x≦0.3, 0≦y≦0.5, 0≦z≦0.5, 0≦m≦0.5 and 0≦n≦0.5. Suitable anodes include those such as lithium metal; graphitic materials, amorphous carbon, Li₄Ti₅O₁₂, tin alloys, silicon alloys, intermetallic compounds, or mixtures of any two or more such materials. Suitable graphitic materials including natural graphite, artificial graphite, graphitized meso-carbon microbeads (MCMB), and graphite fibers, as well as any amorphous carbon materials. In some embodiments, the anode and cathode are separated from each other by a porous separator.

The separator for the lithium battery often is a microporous polymer film. Examples of polymers for forming films include: nylon, cellulose, nitrocellulose, polysulfone, polyacrylonitrile, polyvinylidene fluoride, polypropylene, polyethylene, polybutene, or co-polymers or blends of any two or more such polymers. In some instances, the separator is an electron beam treated micro-porous polyolefin separator. The electron treatment can improve the deformation temperature of the separator and can accordingly enhance the high temperature performance of the separator. Additionally, or alternatively, the separator can be a shut-down separator. The shut-down separator can have a trigger temperature above 130° C. to permit the electrochemical cells to operate at temperatures up to 130° C.

Batteries incorporating the non-aqueous electrolytes are not limited to particular shapes. Such batteries may take any appropriate shape such as cylindrical shape, a coin shape, and a square shape. The batteries also are not limited to particular capacities, and can have any appropriate capacity for both small appliances and power storage or electric cars.

In various embodiments, the electrolyte may be a liquid, a gel, or a solid. For instance, the electrolyte can include a porous phase that absorbs a liquid electrolyte. The porous phase can provide the structure needed for the electrolyte to be a gel or solid. The porous phase can include or consist of a copolymer and one or more silicon compounds that are each selected from a group consisting of silanes and siloxanes. Suitable siloxanes include, but are not limited to, the polysiloxanes, tetrasiloxanes, trisiloxanes, and disiloxanes disclosed above. The copolymer and the one or more silicon compounds can be microphase separated in the porous phase. The liquid electrolyte can include one or more of the above salts dissolved in a liquid solvent. The liquid solvent can include one or more of the above organic solvents and/or one or more of the above siloxanes and/or one or more of the above silanes.

In some other embodiments, the inventive electrolyte of the present invention comprises an aprotic gel polymer carrier/solvent. Suitable gel polymer carrier/solvents include polyethers, polyethylene oxides, polyimides, polyphosphazines, polyacrylonitriles, polysiloxanes, polyether grafted polysiloxanes, derivatives of the foregoing, copolymers of the foregoing, cross-linked and network structures of the foregoing, blends of the foregoing, and the like, to which is added an appropriate ionic electrolyte salt. Other gel-polymer carrier/solvents include those prepared from polymer matrices derived from polypropylene oxides, polysiloxanes, sulfonated polyimides, perfluorinated membranes (Nafion resins), divinyl polyethylene glycols, polyethylene glycol-bis-(methyl acrylates), polyethylene glycol-bis(methyl methacrylates), derivatives of the foregoing, copolymers of the foregoing, cross-linked and network structures of the foregoing.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present invention, thus generally described, will be understood more readily by reference to the following examples, which are provided by way of illustration and are not intended to be limiting of the present invention.

### EXAMPLES

### Example 1

Electrolyte Preparation. A non-aqueous electrolyte was prepared by dissolving LiPF₆ in a mixture of TMS and 1NM3 with weight ratios of 9:1, 4:1, 7:3, 1:1 at room temperature. The concentration of the LiPF₆ in the solvent mixture was 1.0 M. As used herein TMS refers to tetramethylene sulfone, and 1NM3 is an abbreviation for 3-[2-[2-[2-methoxy-ethoxy]-ethoxy]-ethoxy]-1,1,1-trimethyl siloxane or Me(OCH₂CH₂)₃OSiMe₃.

Conductivity cells were then prepared by sandwiching a certain amount of electrolytes between two stainless steel spacers separated by a hard plastic O-ring. The AC impedance of the electrolyte was then collected in the range of 0.01 to 1 MHz, and the real impedance which is at the minimum of imaginary impedance was used as the resistance to calculate the conductivity of the electrolyte. The conductivity of the electrolyte was then determined using a Solatron potentiostat equipped with a frequency responsive analyzer.

### Example 2

Conductivity of Non-Aqueous Electrolyte Comprising Binary Solvents. A series of sulfone/silane binary solvent electrolytes were prepared by mixing TMS and 1NM3 in weight ratios of 9:1, 4:1, 7:3 and 1:1. LiPF₆ was dissolved in each mixed solvent to a concentration of 1.0 mol/L. Conductivity cells were then prepared by sandwiching a certain amount of electrolytes between two stainless steel spacers separated by a hard plastic O-ring

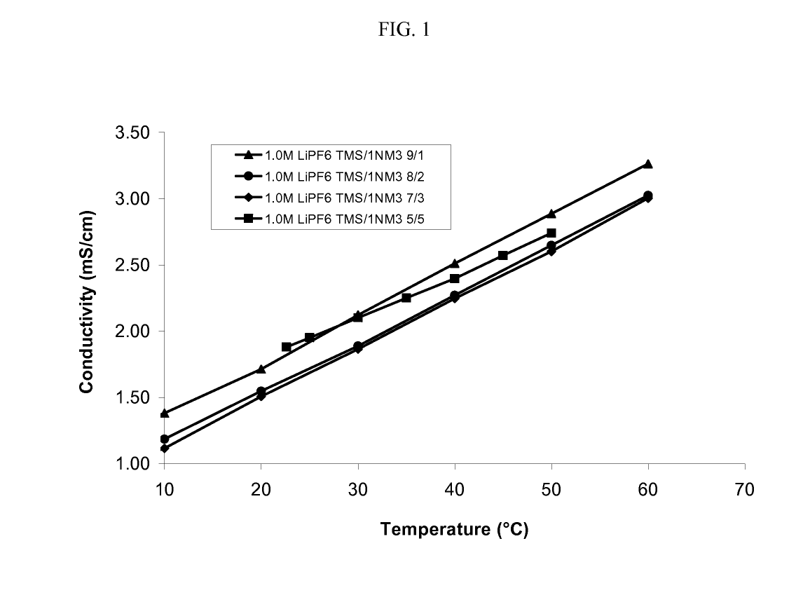

The conductivity cells were placed inside a temperature programmable environmental chamber for wide range temperature measurements. The conductivity-temperature curves that were determined are illustrated in FIG. 1. The TMS:1NM3 at a weight ratio of 9:1 is shown by “▪”; the TMS:1NM3 at a 4:1 weight ratio is shown by “♦”; the TMS/1NM3 at a weight ratio of 7:3 is shown by “”; and the TMS:1NM3 at a weight ratio of 1:1 is shown by “▴”. At 25° C., the 1:1 mixture electrolyte had a conductivity of 1.95×10⁻³ S/cm.

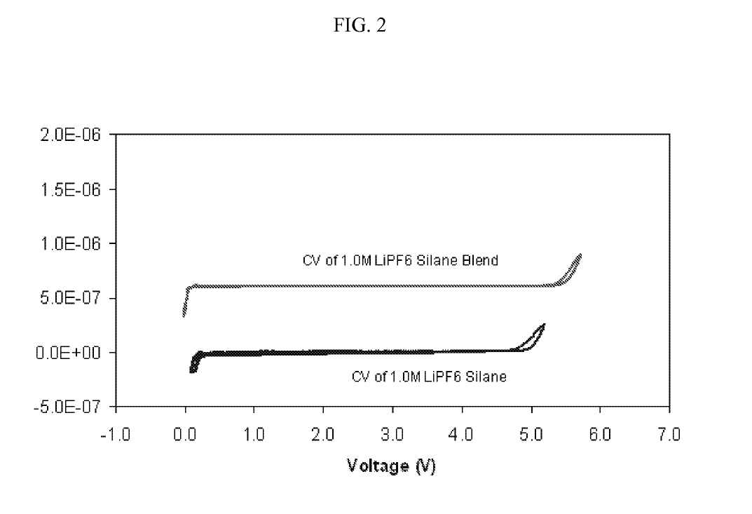

A two electrode (Pt/Ag—AgCl) cell was used for the cyclic voltammetry measurements. The electrolytes used were 1NM3 with 1.0M LiPF₆ and TMS/1NM3 (1:1) with 1.0M LiPF₆. Cyclic voltammograms of the electrolytes calibrated to the potential vs Li⁺/Li is shown in FIG. 2. It clearly showed that the oxidation potential of the mixture TMS/1NM3 electrolyte is higher than that of the 1NM3/LiPF₆ electrolyte. Thus, the sulfone-silane combination provides a synergistic effect that allows for a higher oxidation potential and greater stability of the electrolyte.

### Example 3

Lithium Ion Cell Employing Binary Solvent Electrolyte. A cell was prepared using a cathode, Li₄Ti₅O₁₂ as an anode, and a microporous polypropylene separator (Celgard 2325). An electrolyte of 1.0 M LiPF₆ in TMS:1NM3 at a weight ratio of 1:1 was added. The cathode used was a laminate of 84 wt % Li_{1.2}Ni_{0.15}Co_{0.10}Mn_{0.55}O₂, 4 wt % acetylene black, 4 wt % graphite (SFG-6), and 8 wt % poly(vinylidene fluoride) (PVDF).

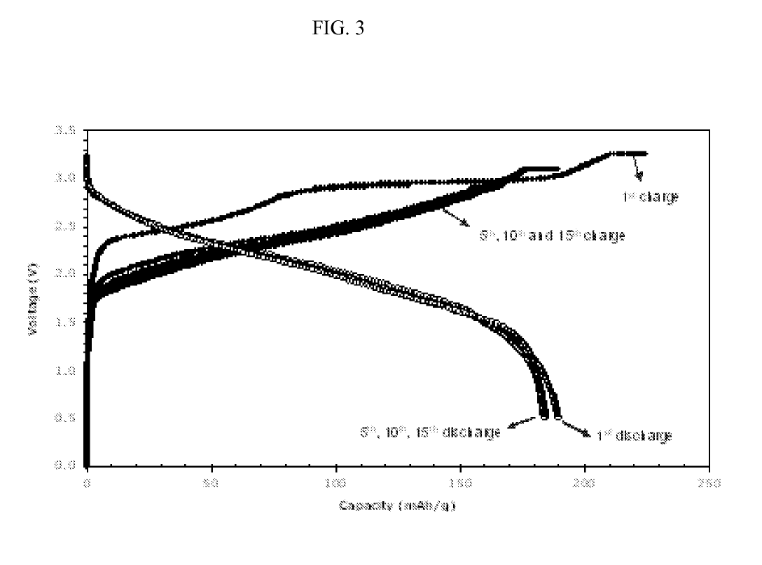

2032 test cells were assembled by placing Celgard 2325 separator, soaked in the electrolyte described in Example 2, between a cathode of Li_{1.2}Ni_{0.15}Co_{0.10}Mn_{0.55}O₂ and an anode of Li₄Ti₅O₁₂. The cells were cycled between 3.4 and 0.5 V. The first charge and discharge voltage profiles, illustrated in FIG. 3, were done at a rate of C/20, together with 5^{th} and 10^{th} cycle charge and discharge profiles.

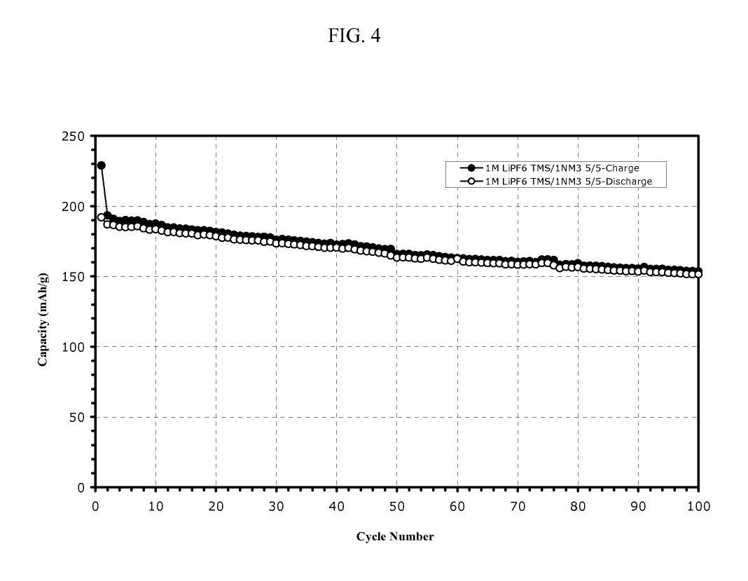

As shown in FIG. 3, the fist charging curve exhibits two distinct plateau regions, which may be attributed to the activation process of the cathode active material. No such plateaus are observed in the subsequent cycles. The 1^{st} discharge specific capacity is slightly lower than 5^{th}, 10^{th} and 15^{th} cycles with a value from about 180 to 190 mAh/g. The cycling curve for the sample is shown in FIG. 4, and shows that the sample has over 80% capacity retention. This retention capacity indicates that the electrolyte is suitable high energy lithium ion battery applications.

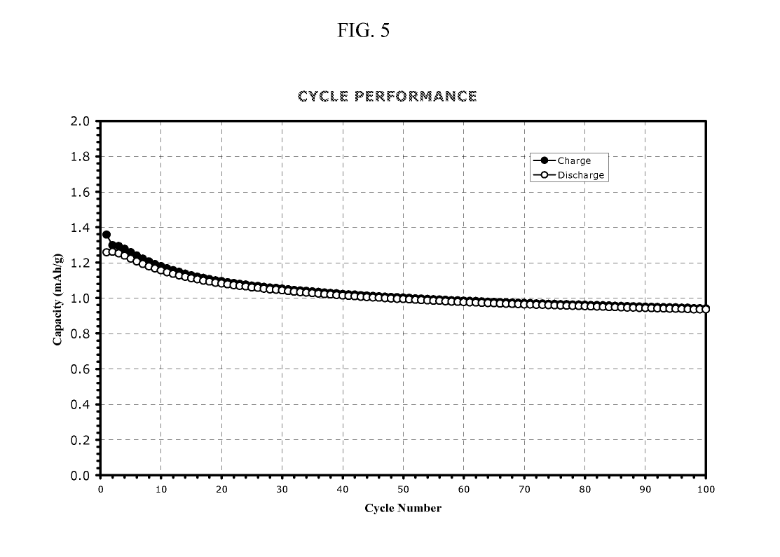

A second cell was prepared with a laminated cathode including 84 wt % LiMn₂O₄, 4 wt % acetylene black, 4 wt % graphite (SFG-6), and 8 wt % poly(vinylidene fluoride) (PVDF). The cycling curve of the cell with Li₄Ti₅O₁₂ as the anode is shown in FIG. 5, at a cycling current of C/10. The 1 M LiPF₆ in 1:1 TMS:1NM3 electrolyte showed stable cycling over 100 cycles at room temperature.

### Example 4

Lithium Ion Cell Employing Binary Electrolyte with Additive. As an example, a sulfone/silane binary solvent electrolytes with Li[BF₂C₂O₄] or vinylene carbonate as an electrolyte additive were prepared by mixing TMS and 1NM3 in weight ratios of 9:1; 4:1; 7:3; and 1:1. After dissolving LiPF₆ the solvent mixture to a concentration of 1.0 mol/L, the additive was added to the electrolyte at a weight percentage of about 2% or about 4%. Conductivity cells were prepared using a cathode, an anode, and a microporous polypropylene separator (Celgard 2325) with an appropriate amount of an electrolyte of 1.0 M LiPF₆ TMS:1NM3 in 1:1 weight ratio. The cathode included 84 wt % LiNi_{0.33}Mn_{0.33}Co_{0.33}O₂, 8 wt % SuperP carbon black, and 8 wt % poly(vinylidene fluoride) (PVDF) as binder. The anode included 90 wt % MCMB (mesocarbon microbeads) 10-28, 2 wt % carbon fiber, and 8 wt % poly(vinylidene fluoride) (PVDF) as binder. After preparation, the conductivity cells were placed inside a temperature programmable environmental chamber for wide range temperature measurement.

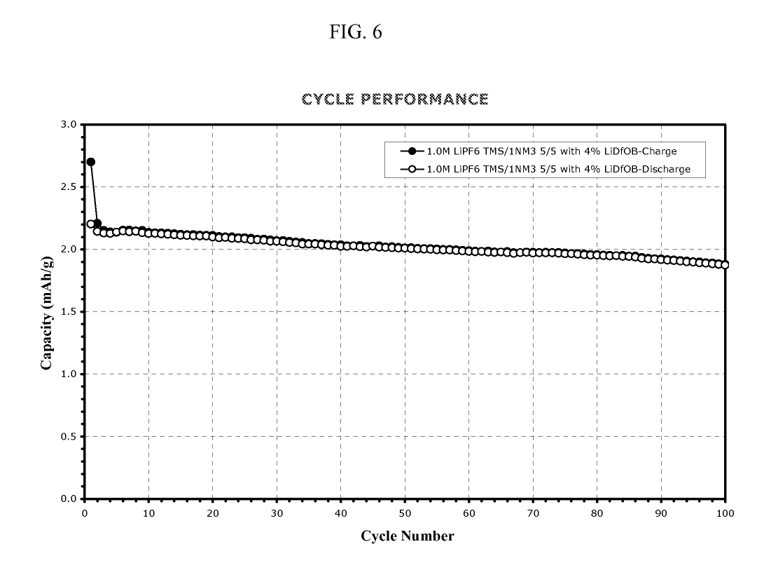

FIG. 6 is a graph illustrating the cycling performance of the lithium ion cell using an electrolyte 1.0M LiPF₆ in TMS:1NM3 at a 1:1 weight ratio with 4 wt % LiDfOB, and using LiNi_{1/3}Mn_{1/3}Co_{1/3}O₂ as the positive electrode, MCMB as the negative electrode and Celgard 2325 as the separator.

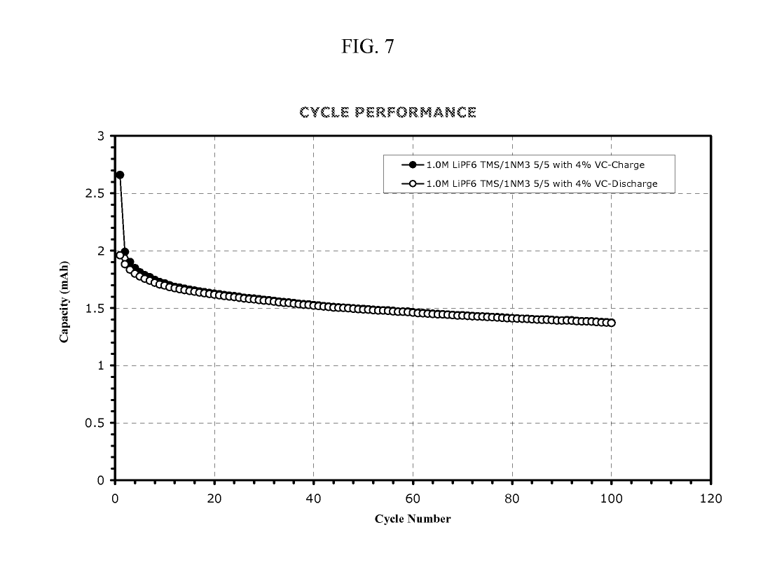

FIG. 7 is a graph illustrating the cycling performance of a lithium ion cell using an electrolyte of 1.0M LiPF₆ in TMS:1NM3 at a 1:1 weight ratio with 2% VC, and using LiNi_{1/3}Mn_{1/3}Co_{1/3}O₂ as a positive electrode, MCMB as a negative electrode, and Celgard 2325 as a separator.

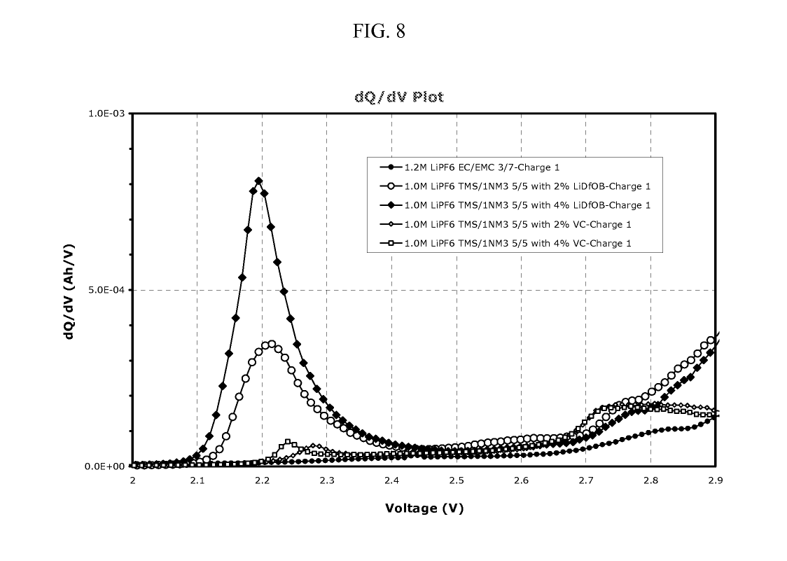

FIG. 8 is a graph of 1^{st} charge dQ/dV plots for cells using NMC as cathode and MCMB as anode. The electrolytes illustrated are 1.2M LiPF₆ in EC/EMC at a weight ratio of 3/7; 1.0M LiPF₆ in TMS:1NM3 at a weight ratio of 1:1 with 2% Li[BF₂C₂O₄] (“LiDfOB”), 2% vinylene carbonate (“VC”), and of 4% LiDfOB and 4% VC.

While certain embodiments have been illustrated and described, it should be understood that changes and modifications can be made therein in accordance with ordinary skill in the art without departing from the invention in its broader aspects as defined in the following claims.

What is claimed is:

1. A non-aqueous electrolyte comprising:
a ionic electrolyte salt;
a non-aqueous electrolyte solvent comprising two or more of:
a siloxane or a silane or a mixture thereof
a sulfone;
a fluorinated ether or fluorinated ester or a mixture thereof; and
a room temperature ionic liquid.

2. The non-aqueous electrolyte of claim 1, wherein the non-aqueous electrolyte solvent comprises one or more siloxanes.

3. The non-aqueous electrolyte of claim 2, wherein the one or more siloxanes comprise (CH₃)₃SiO(CH₂CH₂O)ₙCH₃; (CH₃)₃SiCH₂O(CH₂CH₂O)ₙCH₃; (CH₃)₃Si(CH₂)₃O(CH₂CH₂O)_{n′}CH₃; (CH₃)₂Si[O(CH₂CH₂O)_{n′}CH₃]₂; CH₃Si[O(CH₂CH₂O)ₚCH₃]₃; Si[O(CH₂CH₂O)ₚCH₃]₄; (CH₃)₂Si[O(CH₂CH₂O)_{n′}CH₃][(CH₂)₃O(CH₂CH₂O)_{n′}CH₃]; (CH₃)₃SiOR; (CH₃)₃Si(CH₂)₃OR; CH₃O(CH₂CH₂O)ₙSi(CH₃)₂O(CH₃)₂SiO(CH₂CH₂O)ₙCH₃, CH₃O(CH₂CH₂O)ₙCH₂Si(CH₃)₂O(CH₃)₂SiCH₂O(CH₂CH₂O)ₙCH₃, CH₃O(CH₂CH₂O)ₙ(CH₂)₃Si(CH₃)₂O(CH₃)₂Si(CH₂)₃O(CH₂CH₂O)ₙCH₃, (CH₃)₃SiO(CH₃)₂Si(CH₂)₃O(CH₂CH₂O)ₙCH₃, (CH₃)₃SiO(CH₃)₂Si(CH₂)₂O(CH₂CH₂O)ₙCH₃, (CH₃)₃SiO(CH₃)₂SiO(CH₂CH₂O)ₙCH₃, (CH₃)₃SiO(CH₃)₂SiOR; ROSi(CH₃)₂O(CH₃)₂SiO—R; (CH₃)₃SiO(CH₃)₂Si(CH₂)₃OR; RO(CH₂)₃Si(CH₃)₂O(CH₃)₂Si(CH₂)₃OR; CH₃O(CH₂CH₂O)ₙSi(CH₃)₂OSi(CH₃)₂O(CH₃)₂SiO(CH₂CH₂O)ₙCH₃, CH₃O(CH₂CH₂O)_{n′}(CH₂)₃Si(CH₃)₂OSi(CH₃)₂O(CH₃)₂Si(CH₂)₃O(CH₃)₂Si—(OCH₂CH₂)_{n′}OCH₃, [(CH₃)₃SiO]₂Si(CH₃)O(CH₂CH₂O)ₙCH₃, [(CH₃)₃SiO]₂Si(CH₃)(CH₂)₃O(CH₂CH₂O)ₙCH₃, [(CH₃)₃SiO]₂Si(CH₃)O(CH₂CH₂O)ₙ(CH₃)Si[OSi(CH₃)₃]₂, ROSi(CH₃)₂OSi(CH₃)₂O(CH₃)₂SiOR, ROSi(CH₃)₂OSi(CH₃)₂OSi(CH₃)₃, RO(CH₂)₃Si(CH₃)₂OSi(CH₃)₂O(CH₃)₂Si(CH₂)₃OR, RO(CH₂)₃Si(CH₃)₂OSi(CH₃)₂OSi(CH₃)₃; ROSi(CH₃)₂OSi(CH₃)₂O(CH₃)₂SiO(CH₂CH₂)ₙCH₃, or RO(CH₂)₃Si(CH₃)₂OSi(CH₃)₂O(CH₃)₂Si(CH₂)₃O(CH₂CH₂)ₙCH₃
wherein:
R is a carbonate group;
n is 2, 3, 4, 5, 6, or 7;
n′ is 2, 3, 4, or 5;
p is 2, 3, or 4; and
p′ is 2 or 3.

4. The non-aqueous electrolyte of claim 1, wherein the sulfone is represented by Formula I: 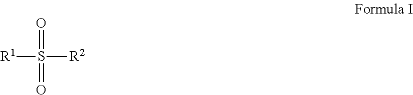
wherein:
R¹ and R² are individually:
a C₁-C₇ alkyl group that is unsubstituted, or is substituted with one or more fluorine atoms; or
a C₁-C₇ group having one or more oxygen atoms; or
R¹ and R² join together to form a cyclic alkyl that is unsubstituted or is substituted with one or more fluorine atoms.

5. The non-aqueous electrolyte of claim 4, wherein R¹ and R² are individually selected from the group consisting of methyl, ethyl, n-propyl, iso-propyl, n-butyl, iso-butyl, sec-butyl, tert-butyl, n-pentyl, iso-pentyl, n-hexyl, n-heptyl, trifluoromethyl, 2,2,2-trifluoroethyl, 1,1-difluoroethyl, perfluoroethyl, 3,3,3-trifluoro-n-propyl, 2,2-difluoro-n-propyl, 1,1-difluoro-n-propyl, 2,2,3,3,3-pentafluoro-n-propyl, 1,1,3,3,3-pentafluoro-n-propyl, perfluoro-n-propyl, perfluoro-n-butyl, perfluoro-n-pentyl, perfluoro-n-hexyl, perfluoro-n-heptyl, —CH₂OCH₃, —CF₂OCH₃, —CF₂OCF₃, —CH₂CH₂OCH₃, —CH₂CF₂OCH₃, —CF₂CH₂OCH₃, —CF₂CF₂OCH₃, —CF₂CF₂OCF₃, —CF₂CH₂OCF₃, —CH₂CF₂OCF₃, —CH₂CH₂OCF₃, —CHFCF₂OCF₂H, —CF₂CF₂OCF(CF₃)₂, —CF₂CH₂OCF(CF₃)₂, —CH₂CF₂OCF(CF₃)₂, —CH₂CH₂OCF(CF₃)₂, —CF₂CF₂OC(CF₃)₃, —CF₂CH₂OC(CF₃)₃, —CH₂CF₂OC(CF₃)₃, —CH₂CH₂OC(CF₃)₃, —CH₂CH₂OCH₂CH₃, —CH₂CH₂OCH₂CF₃, —CH₂CH₂OCF₂CH₃, —CH₂CH₂OCF₂CF₃, —CH₂CF₂OCH₂CH₃, —CH₂CF₂OCF₂CH₃, —CH₂CF₂OCH₂CF₃, —CH₂CF₂OCF₂CF₃, —CF₂CH₂OCH₂CH₃, —CF₂CH₂OCF₂CH₃, —CF₂CH₂OCH₂CF₃, —CF₂CH₂OCF₂CF₃, —CF₂CF₂OCH₂CH₃, —CF₂CF₂OCF₂CH₃, —CF₂CF₂OCH₂CF₃, —CF₂CF₂OCF₂CF₃, —CF₂CF₂CF₂OCH₃, —CF₂CF₂CH₂OCH₃, —CF₂CH₂CF₂OCH₃, —CH₂CF₂CF₂OCH₃, —CH₂CF₂CH₂OCH₃, —CH₂CH₂CF₂OCH₃, —CF₂CH₂CH₂OCH₃, —CH₂CH₂CH₂OCH₃, —CF₂CF₂CF₂OCF₃, —CF₂CF₂CH₂OCF₃, —CF₂CH₂CF₂OCF₃, —CH₂CF₂CF₂OCF₃, —CH₂CH₂CF₂OCF₃, —CH₂CF₂CH₂OCF₃, —CF₂CH₂CH₂OCF₃, —CH₂CH₂CH₂CH₂OCH₃, —CH₂CH₂CH₂CH₂CH₂OCH₃, —CH₂CH₂CH₂CH₂CH₂CH₂OCH₃, —CH₂CH₂OCH₂CH₂OCH₃, and —CH₂CH₂OCH₂CH₂OCH₂CH₂OCH₃; or
R¹ and R² join together to form a tetramethylene group.

6. The non-aqueous electrolyte of claim 1, wherein the fluorinated ester comprises a fluorinated carbonate.

7. The non-aqueous electrolyte of claim 6, wherein the fluorinated carbonate is represented by Formula II: 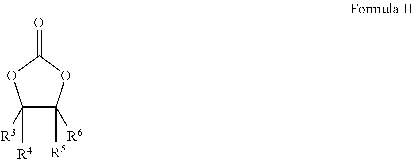
wherein:
R³ is a fluorine-containing alkyl group, a fluorine-containing alkoxyl group or a fluorine-containing ether group with two or more carbon atoms;
R⁴ and R⁵ are individually H, F, Cl, CF₃ or CH₃; and
R⁶ is H, F, Cl or an alkyl group.

8. The non-aqueous electrolyte of claim 7, wherein R³ is a C₁-C₅ alkyl group having at least one F, and that is optionally further substituted with one or more Cl.

9. The non-aqueous electrolyte of claim 8, wherein the C₁-C₅ alkyl group having at least one F, and that is optionally further substituted with one or more Cl, is selected from the group consisting of: CF₃, CF₃CH₂—, CF₃CF₂—, CF₃CH₂CH₂—, CF₃CF₂CH₂—, CF₃CF₂CF₂—, CF₃CH₂CF₂—, CF₃CH₂CH₂CH₂—, CF₃CF₂CH₂CH₂—, CF₃CH₂CF₂CH₂—, CF₃CF₂CF₂CH₂—, CF₃CF₂CF₂CF₂—, CF₃CF₂CH₂CF₂—, CF₃CH₂CH₂CH₂CH₂—, CF₃CF₂CH₂CH₂CH₂—, CF₃CH₂CF₂CH₂CH₂—, CF₃CF₂CF₂CH₂CH₂—, CF₃CF₂CF₂CF₂CH₂—, CF₃CF₂CH₂CF₂CH₂—, CF₃CF₂CH₂CH₂CH₂CH₂—, CF₃CF₂CF₂CF₂CH₂CH₂—, CF₃CF₂CH₂CF₂CH₂CH₂—, HCF—, HCF₂CH₂—, HCF₂CF₂—, HCF₂CH₂CH₂—, HCF₂CF₂CH₂—, HCF₂CH₂CF₂—, HCF₂CF₂CH₂CH₂—, HCF₂CH₂CF₂CH₂—, HCF₂CF₂CF₂CF₂—, HCF₂CF₂CH₂CH₂CH₂—, HCF₂CH₂CF₂CH₂CH₂—, HCF₂CF₂CF₂CF₂CH₂—, HCF₂CF₂CF₂CF₂CH₂CH₂—, FCH—, FCH₂CH₂—, FCH₂CF₂—, FCH₂CF₂CH₂—, FCH₂CF₂CF₂—, CH₃CF₂CH₂—, CH₃CF₂CF₂—, CH₃CH₂CH₂—, CH₃CF₂CH₂CF₂—, CH₃CF₂CF₂CF₂—, CH₃CH₂CF₂CF₂—, CH₃CF₂CH₂CF₂CH₂—, CH₃CF₂CF₂CF₂CH₂—, CH₃CF₂CF₂CH₂CH₂—, CH₃CH₂CF₂CF₂CH₂—, CH₃CF₂CH₂CF₂CH₂—, CH₃CF₂CH₂CF₂CH₂CH₂—, CH₃CF₂CH₂CF₂CH₂CH₂—, HCFClCF₂CH₂—, HCF₂CFClCH₂, HCF₂CFClCF₂CFClCH₂— and HCFClCF₂CFClCF₂CH₂—.

10. The non-aqeuous electrolyte of claim 6, wherein the fluorinated carbonate is represented by Formula III, 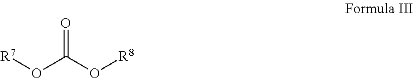
wherein R⁷ and R⁸ are individually a fluorine-containing C₁ to C₈ alkyl group, a fluorine-containing C₁ to C₈ alkoxyl group or a fluorine-containing C₁ or C₂ ether group.

11. The non-aqeuous electrolyte of claim 10, wherein the fluorinated carbonate comprises [H(CF₂)₂CH₂]₂CO₃; HF₂CCF₂CH₂OC(O)OCH₂CF₂CH₂F; HF₂CCF₂CH₂OC(O)OCH₂CH₂CF₂CF₂H; FH₂CCF₂CH₂OC(O)OCH₂CF₂CF₂H; [FCH₂CF₂CH₂]₂CO₃; FCH₂CF₂CH₂OC(O)OCH₂CH₂CF₂CF₂H; HF₂CCF₂CH₂CH₂OC(O)OCH₂CF₂CF₂H; HF₂CCF₂CH₂CH₂OC(O)OCH₂CF₂CH₂F; [HF₂CCF₂CH₂CH₂]₂CO₃; CF₃CF₂CH₂OC(O)OCH₂CF₂CF₂H; CF₃CF₂CH₂OC(O)OCH₂CF₂CH₂F; CF₃CF₂CH₂OC(O)OCH₂CH₂CF₂CF₂H; CF₃CH₂CH₂OC(O)OCH₂CF₂CF₂H; CF₃CH₂CH₂OC(O)OCH₂CF₂CH₂F; CF₃CH₂CH₂OC(O)OCH₂CH₂CF₂CF₂H; (CF₃)₂CFCH₂CH₂OC(O)OCH₂CF₂CF₂H; (CF₃)₂CFCH₂CH₂OC(O)OCH₂CF₂CH₂F; or (CF₃)₂CFCH₂CH₂OC(O)OCH₂CH₂CF₂CF₂H.

12. The non-aqeuous electrolyte of claim 1, wherein the fluorinated ether comprises F₃CCHFCF₂OCH₃; F₃CCHFCF₂OCH₂F; F₃CCHFCF₂OCF₂H; F₃CCHFCF₂OCF₃; (CF₃)₂CHCF₂OCH₃; (CF₃)₂CHCF₂OCH₂F; (CF₃)₂CHCF₂OCHF₂; (CF₃)₂CHCF₂OCF₃; F₃CFC═CFOCH₃; F₃CFC═CFOCH₂F; F₃CFC═CFOCHF₂; F₃CFC═CFOCF₃; F₂C═CFCF₂OCH₃; F₂C═CFCF₂OCH₂F; F₂C═CFCF₂OCF₂H; F₂C═CFCF₂OCF₃; (CF₃)₂C═CFOCH₃; (CF₃)₂C═CFOCH₂F; (CF₃)₂C═CFOCF₂H; (CF₃)₂C═CFOCF₃; F₂C═C(CF₃)CF₂OCH₃; F₂C═C(CF₃)CF₂OCH₂F; F₂C═C(CF₃)CF₂OCF₂H; or F₂C═C(CF₃)CF₂OCF₃.

13. The non-aqueous electrolyte of claim 1, wherein the non-aqueous electrolyte solvent comprises at least one room temperature ionic liquid.

14. The non-aqueous electrolyte of claim 1, wherein the room temperature ionic liquid is a imidazolium, pyridinium, ammonium, or phosphonium ionic liquid.

15. The non-aqeuous electrolyte of claim 1, wherein the ionic electrolyte salt comprises a a compound reprensented by Formula M^{a+}X^{b-};
wherein:
M^{a+} is an electrochemically stable cation;
X^{b-} is an electrochemical stable anion;
a is 1, 2, 3, or 4; and
b is 1, 2, 3, or 4.

16. The non-aqeuous electrolyte of claim 15, wherein M^{a+} comprises H⁺, tetraalkylammonium, imidazolium; Li⁺, Na⁺, K⁺, Ca²⁺, or Mg²⁺.

17. The non-aqeuous electrolyte of claim 15, wherein X^{b-} comprises [CF₃CO₂]⁻; [C₂F₅CO₂]⁻; [ClO₄]⁻; [BF₄]⁻; [AsF₆]⁻; [PF₆]⁻; [PF₂(C₂O₄)₂]⁻; [PF₄C₂O₄]⁻; [CF₃SO₃]⁻; [N(CF₃SO₂)₂]⁻; [C(CF₃SO₂)₃]⁻; [N(SO₂C₂F₅)₂]⁻; alkyl fluorophosphates; [B(C₂O₄)₂]⁻; [BF₂C₂O₄]⁻; [B₁₂X₁₂₋ₖHₖ]²⁻; or [B₁₀X_{10-k′}H_{k′}]²⁻;
X is OH, F, Cl, or Br;
k is an integer from 0 to 12; and
k′ is an integer from 0 to 10.

18. The non-aqeuous electrolyte of claim 1, wherein the ionic electrolyte salt comprises Li[CF₃CO₂]; Li[C₂F₅CO₂]; Li[ClO₄]; Li[BF₄]; Li[AsF₆]; Li[PF₆]; Li[PF₂(C₂O₄)₂]; Li[PF₄C₂O₄]; Li[CF₃SO₃]; Li[N(CF₃SO₂)₂]; Li[C(CF₃SO₂)₃]; Li[N(SO₂C₂F₅)₂]; lithium alkyl fluorophosphates; Li[B(C₂O₄)₂]; Li[BF₂C₂O₄]; Li₂[B₁₂X₁₂₋ₙHₙ]; or Li₂[B₁₀X₁₀₋ₙHₙ];
X is OH, F, Cl, or Br;
k is an integer from 0 to 12; and
k′ is an integer from 0 to 10.

19. An electrochemical cell comprising:
an anode;
a cathode; and
the non-aqueous electrolyte of claim 1
